(19) United States
(12) Patent Application Publication
(10) Pub. No.: US 2012/0094699 A1
(43) Pub. Date: Apr. 19, 2012

(54) WIRELESS COMMUNICATION TERMINAL, WIRELESS COMMUNICATION BASE STATION, AND WIRELESS COMMUNICATION SYSTEM

(75) Inventors: Takashi Tamura, Kanagawa (JP); Takahisa Aoyama, Kanagawa (JP)

(73) Assignee: PANASONIC CORPORATION, Osaka (JP)

(21) Appl. No.: 13/378,011

(22) PCT Filed: Jun. 17, 2010
(86) PCT No.: PCT/JP2010/004033

§ 371 Date: Dec. 13, 2011

(30) Foreign Application Priority Data
Jun. 22, 2009 (JP) 2009-148122

(51) Int. Cl. H04W 68/00

(52) U.S. Cl. 455/458

(57) ABSTRACT

A wireless communication terminal (10) includes a paging management unit (130) that determines, based on a paging message received by a receiving unit (110), whether there is a modification to the system information about the communication cell from which the paging message has been received, and whether there is a modification to the system information about the other communication cells. A control unit (140) controls the receiving unit (110) to receive a paging passage about a particular communication cell among the communication cells. When the paging management unit (130) determines that there is a modification to the system information about the other communication cells based on the paging message about the particular communication cell, the control unit (140) controls the receiving unit (110) to receive a paging message about a communication cell other than the particular communication cell. When the paging management unit (130) determines that there is a modification to the system information about the communication cell from which the paging message has been received, the control unit (140) controls the receiving unit (110) to receive the system information about that communication cell.

### RELATED APPLICATIONS

This application claims benefit of priority to Japanese Patent Application No. 2009-148122, filed on Jun. 22, 2009, the entire contents of which are incorporated herein by reference.

### TECHNICAL FIELD

The present invention relates to a wireless communication terminal, a wireless communication base station, and a wireless communication system that are capable of performing communications by simultaneously using the respective component carriers of communication cells through carrier aggregation. More particularly, the present invention relates to a wireless communication terminal that receives system information, a wireless communication base station that transmits the system information to the wireless communication terminal, and a wireless communication system including the wireless communication base station and the wireless communication terminal.

### BACKGROUND ART

A standard-setting organization, 3GPP (The 3rd Generation Partnership Project), is trying to standardize LTE (Long Term Evolution) as the next-generation communication standard of W-CDMA (Wideband Code Division Multiple Access).

According to LTE, a wireless communication base station (E-UTRAN Node B, hereinafter referred to simply as a “base station”) in a network (Evolved Universal Mobile Radio Access Network (E-UTRAN)) includes communication cells (hereinafter referred to simply as “cells”), and a wireless communication terminal (User Equipment, hereinafter referred to simply as a “terminal”) belongs to one of the cells. To control terminals, a base station broadcasts system information to the terminals for each cell.

The system information is essential information serving as guidelines for various operations of the terminal. The system information includes system bandwidth information, transmission antenna information, cell information (a cell identifier, cell access inhibition information, cell selection information, and cell re-selection information), broadcast schedule information about system information messages, access class control information, common channel setting, radio resource common setting, and MBSFN subframe allocation information, for example.

FIG. 9 is a diagram showing the classifications of the system information according to LTE. The system information is classified into a master information block (hereinafter referred to as the “MIB”) to be broadcasted through a broadcast channel, and system information blocks (hereinafter referred to as the “SIBs”) to be broadcasted through downlink shared channel. The SIBs are classified on the basis of the contents. Non-Patent Literature 1 defines eleven kinds of SIBs: SIB 1 through SIB 11.

To modify the contents of system information being broadcasted to a terminal in a cell, a base station transmits a paging message having a system information modification set at “on”, using a paging channel. The system information modification is a flag to indicate a modification to system information, and the terminal can recognize a modification made to system information through the system information modification. A modification is made to the system information at the start of a modification period. Therefore, the modified system information starts being broadcasted at the start of the next modification period after the paging message having the system information modification set at “on” is sent.

A paging message includes a paging record list that is a list of combinations of subject terminal identifiers and networks as paging origins, the system information modification indicating whether there is a modification to the system information about own cell, and an etws-indication commanding an earthquake and tsunami alarm system. A paging message may contain all the above information, or may contain only one piece of the information. For example, the system information modification and the etws-indication may be transmitted at the same time, or only one of them may be transmitted.

FIG. 10 is a diagram for explaining the procedures for modifying system information. SIBs having the same broadcast cycles are sent as one message. In the example illustrated in FIG. 10, the SIB 2 and the SIB 3 have the same broadcast cycles, and the SIB 2 and the SIB 3 are sent as one message. To modify system information, a base station sends a paging message having the system information modification set at “on” at the start of the next modification period after the current modification period, and broadcasts the modified system information at the start of the next modification period even after that. In FIG. 10, the SIBs in black represents modified SIBs, and the SIB 1 and the SIB 4 are modified in the example illustrated in FIG. 10. When the base station is to modify system information in a modification period 1, the base station sends paging messages each having the system information modification flag set at “on” in the next modification period 2, and broadcasts the modified system information in the next modification period 3 after that.

According to LTB, terminal states include an idle state (RRC_IDLE) and a connected state (RRC_CONNECTED). Different kinds of SIBs are required for terminals in an idle state and a terminal in a connected state. A terminal receives the necessary SIB in accordance with its terminal state, through a system information acquisition.

FIG. 11 is a diagram for explaining a system information acquisition. As shown in FIG. 11, a base station broadcasts the MIB, the SIB 1, the SIB 2, . . . A terminal receives the MIB and the SIB 1. Among the SIB 2 through the SIB 11, the terminal further receives the SIB determined to be necessary based on the broadcast schedule information about the other SIBs written in the SIB 1.

The procedures for receiving system information in a case where a terminal has an initial connection with a base station are as follows. After being connected to the base station, the terminal is synchronized with the base station. Since the broadcast schedules for the MIB and the SIB 1 are determined in advance, the terminal receives the MIB and the SIB 1. As the SIB 1 contains the broadcast schedule information about the other SIBs, the terminal receives the necessary SIB in accordance with the broadcast schedules. After receiving the SIB 2, the terminal receives a paging message, based on the broadcast schedule information (such as paging cycles) about paging messages contained in the SIB 2.

By using the above-described technique, the terminal receives the system information broadcasted from the base station.

### CITATION LIST

### Non-Patent Literatures

Non-Patent Literature 1: 3GPP TS36.331 v8.5.0 “Evolved Universal Terrestrial Radio Access (E-UTRA) Radio Resource Control (RRC)”
Non-Patent Literature 2: 3GPP TS36.304 v8.5.0 “Evolved Universal Terrestrial Radio Access (E-UTRA); User Equipment (UE) procedures in idle mode”

### SUMMARY OF THE INVENTION

### Problems to be Solved by the Invention

The standard-setting organization, 3GPP, is trying to standardize LTE-A (Long Term Evolution Advanced) as the next-generation communication standard that is compatible with LTE. In LTE-A, introduction of carrier aggregation in which a terminal simultaneously uses the respective component carriers of cells under one base station is being considered. Carrier aggregation is also called band aggregation.

FIG. 12 is a diagram showing an example of carrier aggregation. In the example illustrated in FIG. 12, a terminal simultaneously uses four component carriers having carrier frequencies f1, f2, f3, and f6, among six component carriers having carrier frequencies f1, f2, f3, f4, f5, and f6. By using more than one component carrier in this manner, an increase in communication throughput between the terminal and the base station is expected.

In a case where a terminal uses more than one component carrier, however, the terminal needs to receive information specific to each of the component carriers. By the above described conventional method, a terminal receives paging messages through all the component carriers, and needs to check whether there is a modification to the system information. As a result, the power consumption becomes larger.

The present invention has been made to solve the above problems, and an object thereof is to provide a wireless communication system that can perform communications between a wireless communication terminal and a wireless communication base station through carrier aggregation using component carriers, and can reduce the power consumption by the terminal.

### Means for Solving the Problems

A wireless communication system includes a wireless communication base station and a wireless communication terminal, and is designed to perform communications between the wireless communication base station and the wireless communication terminal by simultaneously using the respective component carriers of cells through carrier aggregation.

The wireless communication base station is capable of communicating with the wireless communication terminal by using the respective component carriers of communication cells through carrier aggregation. The wireless communication base station includes: a paging generating unit that generates a paging message for each of the communication cells when system information about one of the communication cells is modified, the paging message containing information indicating whether there is a modification to system information about the subject communication cell and information indicating whether there is a modification to system information about the communication cells other than the subject communication cell; and a transmitting unit that transmits the paging message generated by the paging generating unit in the communication cell associated with the paging message, and also transmits the system information.

The wireless communication terminal is capable of simultaneously using the respective component carriers of cells through carrier aggregation. The wireless communication terminal includes: a receiving unit that receives a paging message and system information transmitted by the transmitting unit; a paging management unit that determines whether there is a modification to system information about a communication cell from which the paging message has been received, and whether there is a modification to system information about the other communication cells, based on the paging message received by the receiving unit; and a control unit that controls the receiving unit to receive a paging message about a particular communication cell among the communication cells, the control unit controlling the receiving unit to receive a paging message about another communication cell that is not the particular communication cell when the paging management unit determines, based on the paging message about the particular communication cell, that there is a modification to the system information about the other communication cells, the control unit controlling the receiving unit to receive the system information about the communication cell from which the paging message has been received when the paging management unit determines that there is a modification to the system information about the communication cell from which the paging has been received.

### Effects of the Invention

The present invention provides a wireless communication system in which the number of times a terminal receives a paging message in cells other than a particular cell is reduced, and the terminal can receive necessary system information, when the system information about each cell is modified in a case where the terminal is performing carrier aggregation. By providing the wireless communication system, the present invention can reduce the power consumption by terminals.

As will be described later, there are other embodiments of the present invention. Therefore, this disclosure of invention is intended to disclose part of the present invention, and is not intended to limit the scope of the claimed invention.

### BRIEF DESCRIPTION OF THE DRAWINGS

FIG. 1 is a block diagram of a terminal according to a first embodiment of the present invention;

FIG. 2 is a block diagram of a base station according to the first embodiment of the present invention;

FIG. 3 is a flowchart for explaining the outline of a method of broadcasting system information in the first embodiment of the present invention;

FIG. 4 is a diagram for explaining an operation to be performed by the terminal to receive a paging message from the base station in the first embodiment of the present invention;

FIG. 5 is a diagram showing an example of a paging message format in the first embodiment of the present invention;

FIG. 6 is a flowchart for explaining an operation to be performed by the terminal when a paging message is received in a particular cell in the first embodiment of the present invention;

FIG. 7 is a flowchart for explaining an operation to be performed by the terminal when a paging message is received in another cell in the first embodiment of the present invention;

FIG. 8 is a flowchart for explaining an operation to be performed by the base station in the first embodiment of the present invention;

FIG. 9 is a diagram showing the classifications of system information according to LTE;

FIG. 10 is a diagram for explaining the procedures for modifying system information;

FIG. 11 is a diagram for explaining a system information acquisition;

FIG. 12 is a diagram showing an example of carrier aggregation;

FIG. 13 is a diagram showing the entire structure of a wireless communication system of an embodiment of the present invention;

FIG. 14A is a schematic view showing a case where carrier aggregation is performed by simultaneously using component carriers belonging to the same area in an embodiment of the present invention;

FIG. 14B is a schematic view showing a case where carrier aggregation is performed by simultaneously using component carriers belonging to different areas under the same base station in an embodiment of the present invention;

FIG. 14C is a schematic view showing a case where carrier aggregation is performed by simultaneously using component carriers in such a situation that a base station manages cells having sizes varying with frequencies in an embodiment of the present invention;

FIG. 14D is a schematic view showing a case where carrier aggregation is performed by simultaneously using component carriers that belong to different areas under the same base station and have the same carrier frequency in an embodiment of the present invention;

FIG. 15A is a diagram illustrating a method by which the same SIBs are broadcasted in all the cells in carrier aggregation in an embodiment of the present invention;

FIG. 15B is a diagram illustrating a method by which the number of SIBs to be broadcasted in some of the cells is made smaller, and all the other SIBs are broadcasted in the other cells, in carrier aggregation in an embodiment of the present invention;

FIG. 15C is a diagram illustrating a method by which SIBs are not broadcasted in some of the cells, and the other cells broadcast the cell-specific information about some of the cells on behalf of the some of the cells, in carrier aggregation in an embodiment of the present invention;

FIG. 16 is a block diagram of a terminal according to a second embodiment of the present invention;

FIG. 17A is a diagram showing an example of a paging message format having the other cell modification set at “off” in the second embodiment of the present invention;

FIG. 17B is a diagram showing an example of a paging message format that has the other cell modification set at “on”, and has a mod type added, in the second embodiment of the present invention;

FIG. 17C is a diagram showing an example of a paging message format having the other cell modification represented by two bits in the second embodiment of the present invention;

FIG. 18 is a flowchart for explaining an operation to be performed by the terminal in the second embodiment of the present invention;

FIG. 19 is a block diagram of a base station according to the second embodiment of the present invention;

FIG. 20 is a block diagram of a terminal according to a third embodiment of the present invention; and

FIG. 21 is a block diagram of a base station according to the third embodiment of the present invention.

### BEST MODES FOR CARRYING OUT THE INVENTION

The following is a detailed description of the present invention. The embodiments described below are merely examples of the present invention, and various modifications may be made to form various embodiments of the present invention. Therefore, the specific structures and functions disclosed hereafter do not limit the scope of the claimed invention.

A wireless communication system of an embodiment of the present invention includes a wireless communication base station and a wireless communication terminal, and is designed to perform communications between the wireless communication base station and the wireless communication terminal by simultaneously using the respective component carriers of cells through carrier aggregation.

The wireless communication base station is capable of communicating with the wireless communication terminal by using the respective component carriers of communication cells through carrier aggregation. The wireless communication base station includes: a paging generating unit that generates a paging message for each of the communication cells when system information about one of the communication cells is modified, the paging message containing information indicating whether there is a modification to system information about the subject communication cell and information indicating whether there is a modification to system information about the communication cells other than the subject communication cell; and a transmitting unit that transmits the paging message generated by the paging generating unit in the communication cell associated with the paging message, and also transmits the system information.

The wireless communication terminal is capable of simultaneously using the respective component carriers of cells through carrier aggregation. The wireless communication terminal includes: a receiving unit that receives a paging message and system information transmitted by the transmitting unit; a paging management unit that determines whether there is a modification to system information about a communication cell from which the paging message has been received, and whether there is a modification to system information about the other communication cells, based on the paging message received by the receiving unit; and a control unit that controls the receiving unit to receive a paging message about a particular communication cell among the communication cells, the control unit controlling the receiving unit to receive a paging message about another communication cell that is not the particular communication cell when the paging management unit determines, based on the paging message about the particular communication cell, that there is a modification to the system information about the other communication cells, the control unit controlling the receiving unit to receive the system information about the communication cell from which the paging message has been received when the paging management unit determines that there is a modification to the system information about the communication cell from which the paging has been received.

The following is a detailed description of the wireless communication system of the embodiment of the present invention, with reference to the drawings. The wireless communication system of the embodiment of the present invention includes terminals and a base station. Before the terminals and base station that form the wireless communication system are specifically described, carrier aggregation in the wireless communication system of the embodiment of the present invention is explained.

FIG. 13 is a diagram showing the entire structure of the wireless communication system of the embodiment of the present invention. As shown in FIG. 13, the wireless communication system 900 includes terminals 101, 102, and 103, and a base station 500. The base station 500 manages cells for respective component carriers having different carrier frequencies from one another.

In the present invention, a cell is a wireless network object that can be uniquely identified by a terminal based on an identifier sent from a base station to a geographical area or the difference in used frequency.

A terminal can perform communications with a base station through carrier aggregation by simultaneously using the respective component carriers of cells. In the example illustrated in FIG. 13, the terminal 101 performs carrier aggregation by simultaneously using the following four component carriers: the component carrier of a cell 1 (the carrier frequency being f1), the component carrier of a cell 4 (the carrier frequency being f2), the component carrier of a cell 7 (the carrier frequency being f3), and the component carrier of a cell 19 (the carrier frequency being f6). The terminal 103 performs carrier aggregation by simultaneously using the component carrier of a cell 8 (the carrier frequency being f3) and the component carrier of a cell 14 (the carrier frequency being f4). This wireless communication system 900 may include a conventional terminal that does not have a carrier aggregation function like the terminal 102. The terminal 102 performs communications with the base station 500 by using the component carrier of a cell 2 (the carrier frequency being f1).

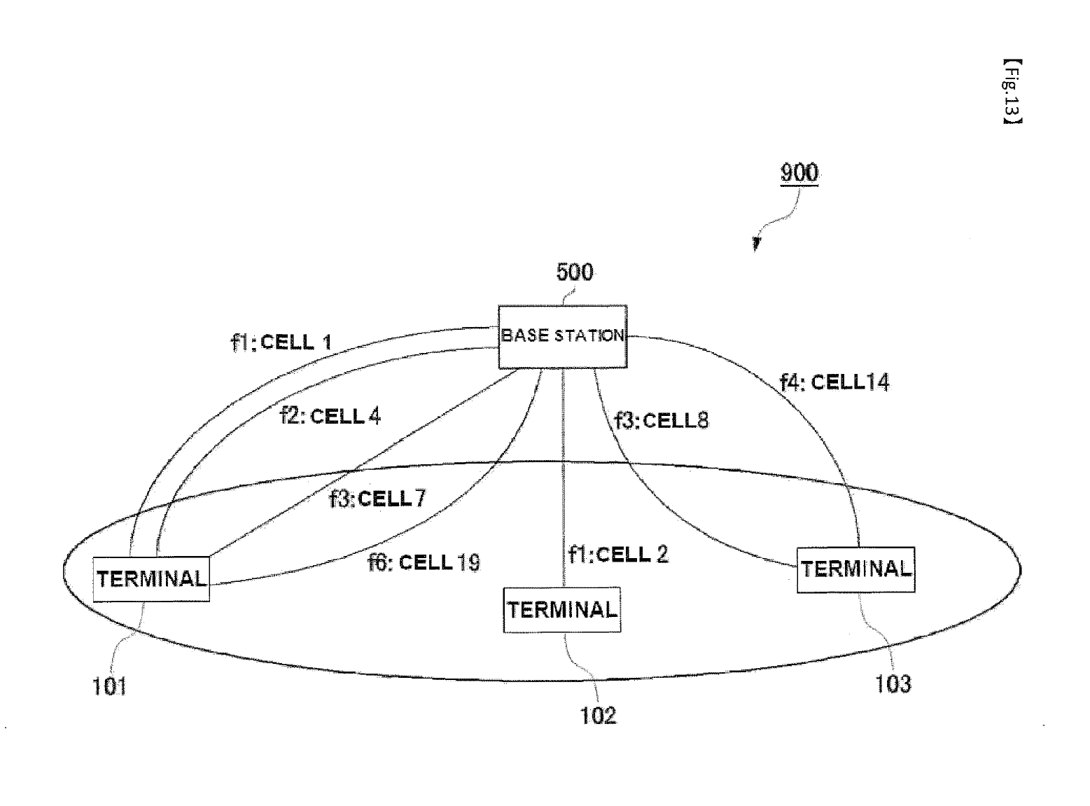

FIGS. 14 are schematic views each showing cells that are managed by a base station. While the respective component carriers of cells are simultaneously used in carrier aggregation, there are various types of combinations of the cells. FIG. 14 show cases where one base station manages three cells (a cell 1, a cell 2, and a cell 3) associated with the carrier frequency f1, and three cells (a cell 4, a cell 5, and a cell 6) associated with the carrier frequency f2.

In cases where component carriers that belong to the same base station and have different carrier frequencies are simultaneously used, component carriers that belong to the same area under the same base station and have different carrier frequencies may be simultaneously used as shown in FIG. 14A, or component carriers that belong to different areas under the same base station and have different carrier frequencies may be simultaneously used as shown in FIG. 14B. Also, in a case where cells that have sizes varying with carrier frequencies under the same base station are managed as shown in FIG. 14C, carrier aggregation is performed likewise. Further, as shown in FIG. 14D, component carriers that belong to different areas under the same base station and have the same carrier frequency may be simultaneously used. In this specification, the case where component carriers having the same carrier frequency are used as shown in FIG. 14D is also called carrier aggregation.

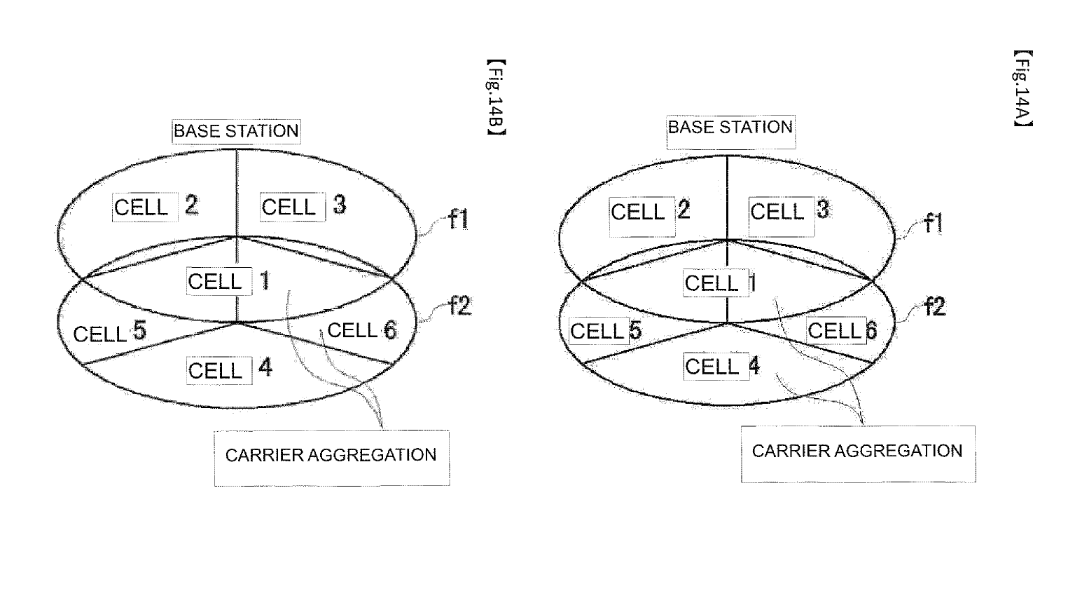

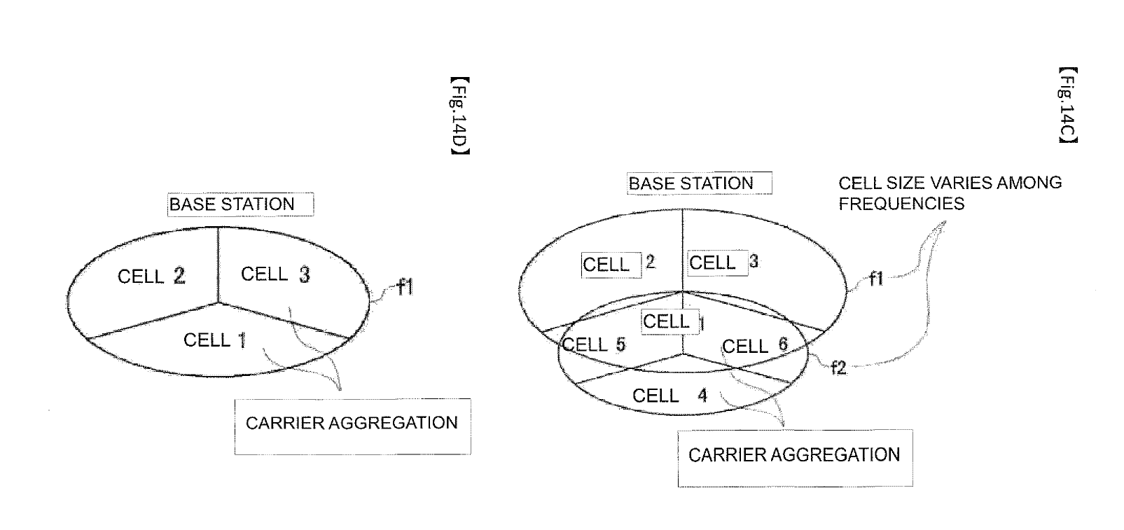

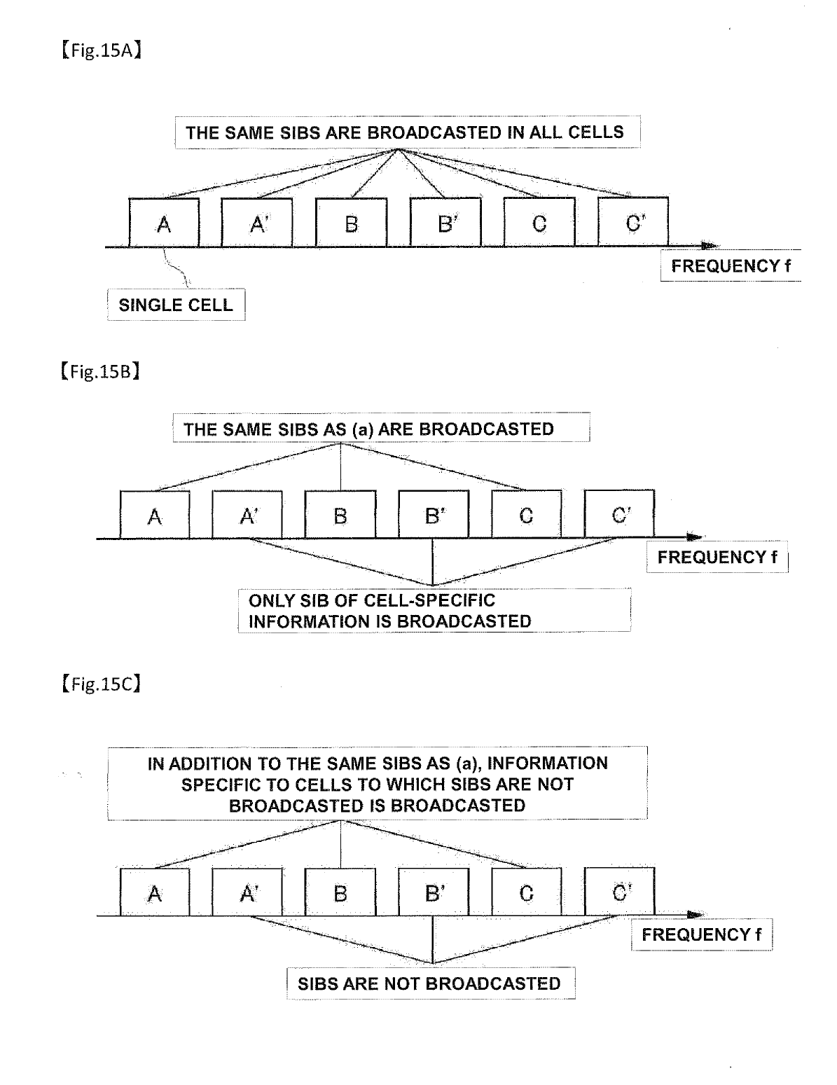

FIG. 15 are diagrams illustrating methods for broadcasting system information in carrier aggregation. There are three example methods for broadcasting system information in carrier aggregation, as illustrated in FIG. 15. In the examples illustrated in FIG. 15, there are six cells A, A′, B, B′, C, and C′ having different carrier frequencies f from one another.

FIG. 15A illustrates a method for broadcasting system information required by LTE terminals, and, if necessary, system information required by LTE-A terminals, in all the cells (A, A′, B, B′, C, and C′), that is, a method for broadcasting the same SIBs in all the cells. Broadcasting the system information required by LTE terminals, those component carriers to which the LTE terminals can be connected are sometimes called backward compatible component carriers.

FIG. 15B illustrates a method by which the same SIBs as those in the case of FIG. 15A are broadcasted in some of the cells (A, B, and C), and the number of SIBs to be broadcasted in the other carriers (A′, B′, and C′) is made smaller (only the SIBs containing the cell-specific information are broadcasted, for example). Those component carriers by which the system information necessary for connecting to LTE terminals is not broadcasted are sometimes called non-backward compatible component carriers.

There are several methods for scheduling SIBs to be broadcasted through non-backward compatible component carriers as in FIG. 15B, and examples of such methods are described below.

A first example is a scheduling method by which the SIB 1 is broadcasted in the cells of the non-backward compatible component carriers so that the cells freely perform scheduling, as in conventional cases.

A second example is a scheduling method by which, if there is a backward compatible component carrier corresponding to a non-backward compatible component carrier, the cell of the non-backward compatible component carrier broadcasts SIBs in the same schedule as the cell of the backward compatible component carrier broadcasting SIBs. That is, the cell A′ broadcasts the SIB 2 at the same time as the cell A broadcasts the SIB 2. In this manner, the number of SIBs that need to be received by a terminal in carrier aggregation through non-backward compatible components can be reduced.

Scheduling methods other than the above-described scheduling methods may be used.

Also, there are several methods for creating SIBS to be broadcasted through backward compatible component carriers in FIG. 15B, and examples of such methods are described below.

A first example is a method for creating SIBS limited to the cell-specific information about the cells of the non-backward compatible component carriers. By this method, the system information to be broadcasted by the base station through the backward compatible component carriers can be reduced, and the radio resources for broadcasting the system information can be saved. The saved radio resources can be allocated to data transmission from each individual terminal or the like. Accordingly, the throughput of terminals can be increased. Also, the system information to be received by terminals can be reduced, and the power consumption by the terminals can be reduced.

A second method is a method for creating SIBs limited to the information (such as the radio resource config common and the MBSFN subframe config list) necessary for maintaining carrier aggregation in the first example. By this method, the system information to be broadcasted by the base station through the backward compatible component carriers can be further reduced, and more radio resources for broadcasting the system information can be saved. The saved radio resources can be allocated to data transmission from each individual terminal or the like. Accordingly, the throughput of terminals can be increased. Also, the system information to be received by terminals can be reduced, and the power consumption by the terminals can be reduced.

A third example is a method for creating SIBs from the differences between the information about the cells of the non-backward compatible component carriers and the information about the cells of the backward compatible component carriers. Specifically, the SIB 1 of the cell A′ is created only from the information different from the SIB 1 of the cell A, and the SIB 2 of the cell A′ is created only from the information different from the SIB 2 of the cell A. As for the other SIBs, each SIB of the cell A′ is also created from the difference from the corresponding SIB of the cell A.

A fourth example is a method by which the SIBs created by differences in the third example are limited to the cell-specific information. Specifically, only the SIB 2 of the cell A′ is created only from the information different from the SIB 2 of the cell A. By this method, the system information to be broadcasted by the base station through the non-backward compatible component carriers can be reduced, and the radio resources for broadcasting the system information can be saved. The saved radio resources can be allocated to data transmission from each individual terminal or the like. Accordingly, the throughput of terminals can be increased. Also, by this method, the system information to be received by terminals can be reduced, and the power consumption by the terminals can be reduced.

A fifth example is a method by which the contents of the SIBs created from differences in the third example are limited to the information (such as the radio resource config common and the MBSFN subframe config list) necessary for maintaining carrier aggregation. By this method, the system information to be broadcasted by the base station through the non-backward compatible component carriers can be further reduced, and the radio resources for broadcasting the system information can be saved. The saved radio resources can be allocated to data transmission from each individual terminal or the like. Accordingly, the throughput of terminals can be increased. Also, by this method, the system information to be received by terminals can be reduced, and the power consumption by the terminals can be reduced.

A sixth example is a method by which the difference SIBs created in the third through fifth examples is combined into one SIB. By this method, the number of SIBs to be broadcasted can be reduced, and scheduling can be performed in a simpler manner. It should be noted that SIBs may be created by any method other than that described above.

FIG. 15C illustrates a method by which SIBs are not broadcasted in some cells (A′, B′, and C′), and the other cells (A, B, and C) broadcast the cell-specific information about some cells (A′, B′, and C′) on behalf of those cells. Specifically, the cell A also broadcasts the cell-specific information about the cell A′, the cell B also broadcasts the cell-specific information about the cell B and the cell C also broadcasts the information about the cell C′.

There are several methods for creating SIBs to be broadcasted through backward compatible component carriers in FIG. 15C, and examples of such methods are described below.

A first example is a method for creating SIBs by incorporating the information about the cells of the non-backward compatible component carriers into the SIBs of the cells of the backward compatible component carriers. Specifically, SIBs are created by incorporating the information about the cell A′ into the SIBs of the cell A. In this manner, the information about the cell A′ can be broadcasted in the cell A without a change in the number of SIBs to be broadcasted in the cell A.

A second example is a method by which the information incorporated into the SIBs of the cells of the backward compatible component carriers in the first example is limited to the cell-specific information about the cells of the non-backward compatible component carriers. By this method, the system information to be broadcasted by the base station through the backward compatible component carriers can be reduced, and the radio resources for broadcasting the system information can be saved. The saved radio resources can be allocated to data transmission from each individual terminal or the like. Accordingly, the throughput of terminals can be increased. Also, the system information to be received by terminals can be reduced, and the power consumption by the terminals can be reduced.

A third example is a method by which the information incorporated into the SIBs of the cells of the backward compatible component carriers in the first example is limited to the information (such as the radio resource config common and the MBSFN subframe config list) necessary for maintaining carrier aggregation about the cells of the non-backward compatible component carriers. By this method, the system information to be broadcasted by the base station through the backward compatible component carriers can be further reduced, and more radio resources for broadcasting the system information can be saved. The saved radio resources can be allocated to data transmission from each individual terminal or the like. Accordingly, the throughput of terminals can be increased. Also, the system information to be received by terminals can be reduced, and the power consumption by the terminals can be reduced.

A fourth example is a method for creating new SIBs from the differences between the information about the cells of the non-backward compatible component carriers and the information about the cells of the backward compatible component carriers. Specifically, a SIBx1 is created from the difference between the SIB 1 of the cell A and the SIB 1 of the cell A′, and a SIBx2 is created from the difference between the SIB 2 of the cell A and the SIB 2 of the cell A′. As for each of the other SIBs, a new SIB is created from such a difference. In this case, terminals in an idle state do not read new SIBs, so as to avoid reception of extra information. Accordingly, power consumption can be reduced.

A fifth example is a method by which the SIBs created by differences in the fourth example are limited to only the cell-specific information. Specifically, only a SIB is created from the difference between the SIB 2 of the cell A and the SIB 2 of the cell A′. By this method, the system information to be broadcasted by the base station through the backward compatible component carriers can be reduced, and the radio resources for broadcasting the system information can be saved. The saved radio resources can be allocated to data transmission from each individual terminal or the like. Accordingly, the throughput of terminals can be increased. Also, the system information to be received by terminals can be reduced, and the power consumption by the terminals can be reduced. By further limiting the SIBs to be added, scheduling can be performed in a simpler manner.

A sixth example is a method by which the contents of the SIBs created from differences in the fourth example are limited to the information (such as the radio resource config common and the MBSFN subframe config list) necessary for maintaining carrier aggregation. By this method, the system information to be broadcasted by the base station through the backward compatible component carriers can be further reduced, and radio resources for broadcasting the system information can be saved. The saved radio resources can be allocated to data transmission from each individual terminal or the like. Accordingly, the throughput of terminals can be increased. Also, the system information to be received by terminals can be reduced, and the power consumption by the terminals can be reduced.

A seventh example is a method by which the difference SIBs created in the fifth and sixth examples are combined into one SIB. By this method, the number of SIBs to be added can be reduced, and scheduling can be performed in a simpler manner. It should be noted that SIBs may be created by any method other than that described above.

In FIG. 15, the backward compatible component carrier cells and the non-backward compatible component carrier cells have one-to-one correspondence, however, they may have one-to-many correspondence. For example, the backward compatible component carrier A may correspond to non-backward compatible component carriers A′ and A″. In such a case, SIBs can also be created as those in the above-described manner.

Further, in the fourth through sixth examples in FIG. 15C, the SIBs of the non-backward compatible component carrier cells created from the differences may be combined into one SIB. With this arrangement, the number of SIBs does not need to be changed when the number of non-backward compatible component carrier cells increases.

Although the backward compatible component carrier cells correspond to the non-backward compatible component carrier cells in the examples illustrated in FIG. 15, the base station may notify terminals of the backward compatible component carrier cells and the non-backward compatible component carrier cells. In doing so, the base station may inform the terminals of the correspondence relations when requesting carrier aggregation. In this case, RRC connection reconfiguration is used, for example. Alternatively, the information about the correspondence relations may be included in the system information, and is then broadcasted. In such a case, Inter Freq Carrier Freq Info included in the SIB 5 is extended, and the information about the correspondence relations is added, for example.

The information about the correspondence relations indicates which cell corresponds to which cell, and each pair is represented by a number, for example. The information about the correspondence relations may include information indicating which cell is the backward compatible carrier cell and which cell is the non-backward compatible carrier cell in each pair. As well as the information about the correspondence relations, information indicating whether carrier aggregation can be performed may be included.

The correspondence relations between downlink cells and uplink cells are now described. There are several conceivable examples of the correspondence relations.

In a first example, the downlink cells and the uplink cells can be freely mapped. Specifically, when it is difficult to allocate resources because of signal quality deterioration or congestion in some of the uplink cells, a response to data reception such as ACK or NACK can be transmitted in another uplink cell, and unnecessary re-transmission can be avoided.

In a second example, restrictions are given on the mapping by the downlink cells and the uplink cells. Specifically, a backward compatible component carrier cell and the corresponding non-backward compatible component carrier cell use the same uplink, and component carrier cells not corresponding to the above cells use other uplinks. That is, the cell A and the cell A′ use the same uplink (X, for example), the cell B and the cell B′ use the same uplink carrier (Y, for example), the cell B and the cell B″ cannot use X, and the cell A and the cell A′ cannot use Y. In the correspondence relations in the first example, ACK and NACK can be freely mapped. However, the terminals and the base station need to determine which ACK or NACK corresponds to which data, and the process is complicated. By this method, on the other hand, restrictions are given on the mapping in advance. Accordingly, it is easier to determine which ACK or NACK corresponds to which data. Therefore, the same uplink is also used by a backward compatible component carrier and a non-backward compatible component carrier. Accordingly, there is no need to broadcast information about the uplink in the non-backward compatible component carrier, and the information about the uplink can be eliminated from the radio resource config common.

The present invention can be applied to all of the above examples.

It should be noted that the above described carrier aggregation is merely an example, and the number of cells that can be used in the present invention is not limited to the number used in the above examples. In the present invention, only one cell may be used, depending on conditions (or on the situations).

In the embodiments described below, an example of a wireless communication system is described, and in the wireless communication system, a base station and a terminal can perform communications by using a plurality of component carriers having carrier frequencies (six frequencies f1, f2, f3, f4, f5, and f6, for example). In this case, one base station forms more than one cell for each of the carrier frequencies.

Also, in the embodiments described below, each terminal is a portable telephone device, and each base station is a base station for portable telephone devices. In the embodiments described below, the present invention is applied to LTE and SAE (System Architecture Evolution), which are mobile communication technologies standardized by 3GPP. However, the present invention can be applied not only to the above standards defined by 3GPP, but also to wireless access technologies, such as wireless LANs (wireless Local Area Networks), WiMAX (Worldwide Interoperability for Microwave Access) such as IEEE802.16, IEEE802.16e, or IEEE802.16m, 3GPP2, LTE-A, and the fourth-generation mobile communication technology.

In the following, the wireless communication system, and the terminals and the base station in the wireless communication system of the above-described embodiment of the present invention are described in greater detail.

### First Embodiment

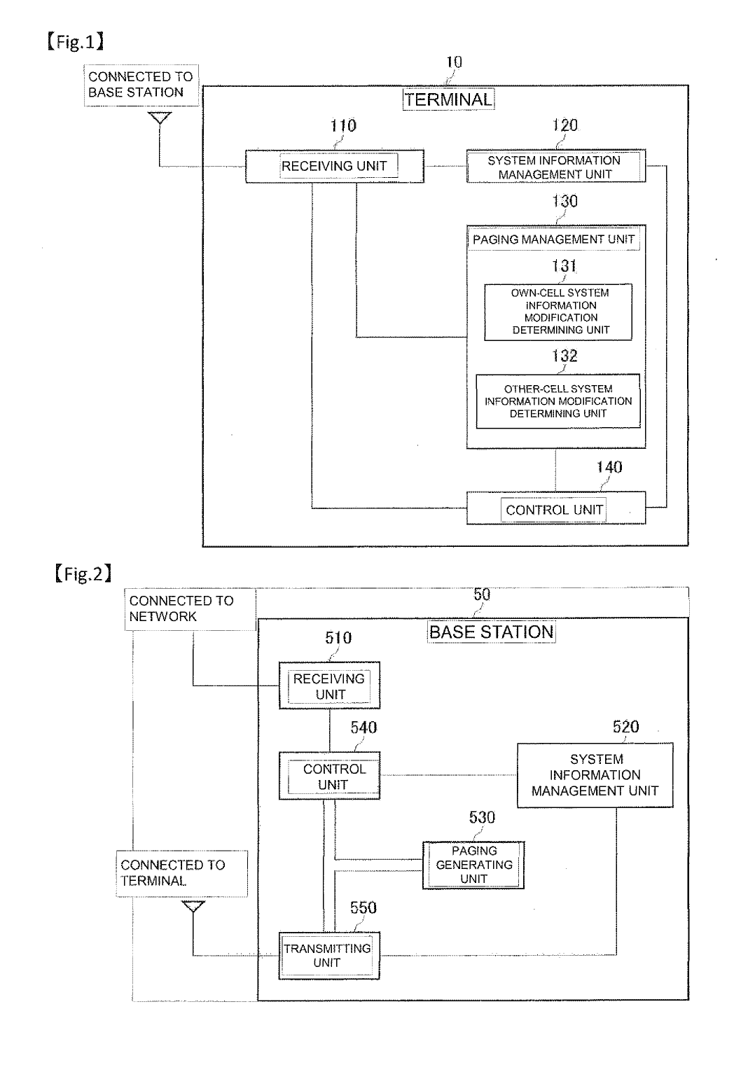

Referring to FIGS. 1 through 8, a wireless communication system according to a first embodiment of the present invention is described. The wireless communication system according to the first embodiment includes a terminal 10 and a base station 50.

FIG. 1 is a block diagram of the terminal 10 of the first embodiment. FIG. 2 is a block diagram of the base station 50 of the first embodiment. In the wireless communication system, the base station 50 allocates and manages radio resources (such as frequency bands in frequency domains or time domains), and serves as an access point in a wireless access network for the terminal 10. The terminal 10 receives a signal transmitted from the base station 50 via a downlink.

Before the terminal 10 and the base station 50 are described in detail, the outline of a method for broadcasting system information in the wireless communication system of this embodiment is described.

### (Outline of the Broadcasting Method)

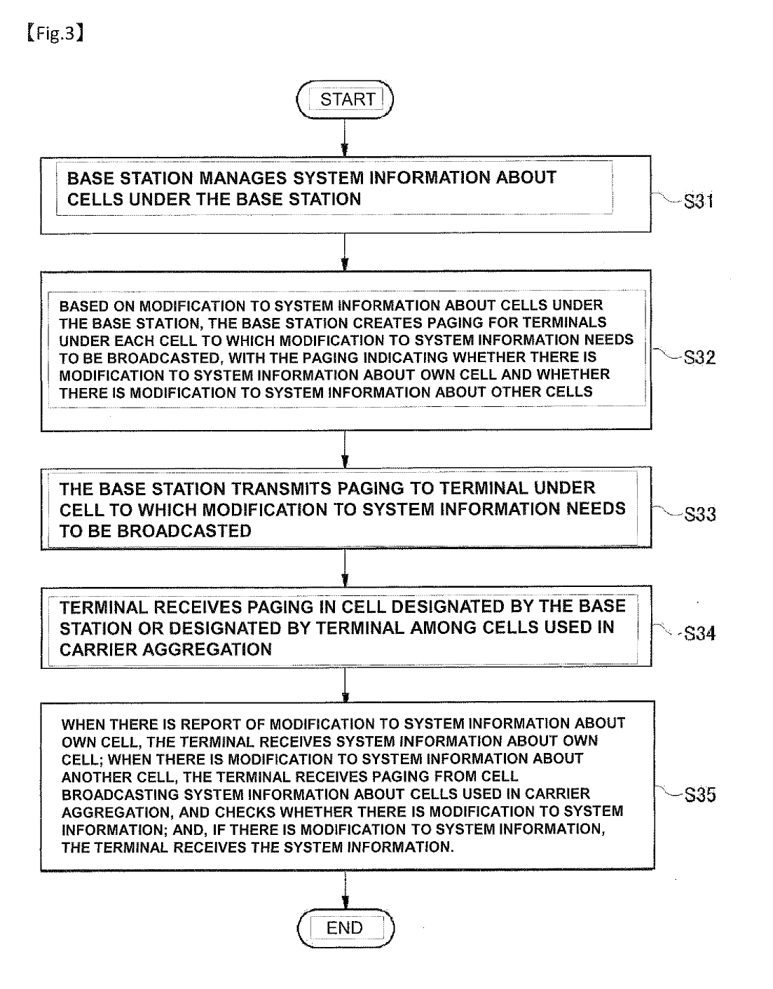

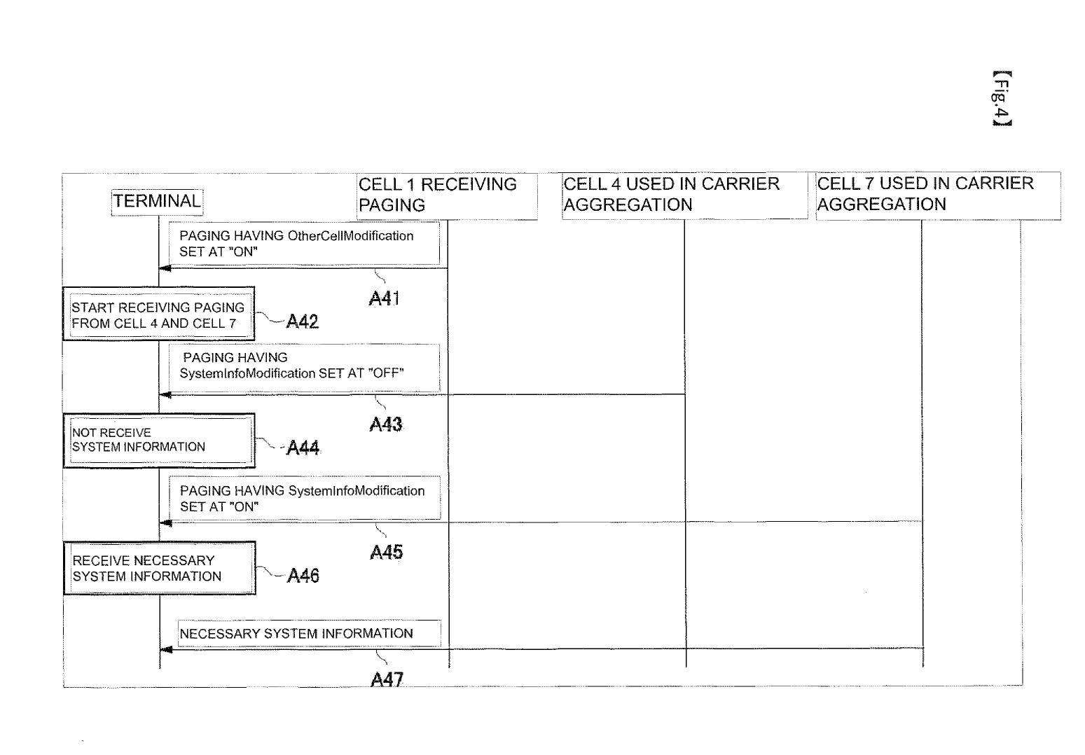

FIG. 3 is a flowchart for explaining the outline of the method for broadcasting system information in the wireless communication system according to the first embodiment.

The base station 50 manages the system information about the cells under the base station 50 (step S31).

Based on a modification to the system information about the cells under the base station 50, the base station 50 creates a paging message (hereinafter referred to simply as the “paging”) for the terminal 10 in the cell to which the modification to the system information needs to be broadcasted (step S32). The paging describes whether there is a modification to the system information about each cell (equivalent to the later described “system information modification”) and whether there is a modification to the system information about the other cells (equivalent to the later described “other cell modification” (OtherCellModification)).

The base station 50 transmits the paging to the terminal 10 in the cell to which the modification to the system information needs to be broadcasted (step S33).

In a particular cell among the cells performing carrier aggregation, the terminal 10 receives the paging (step S34). The particular cell is a cell designated by the base station 50 itself, or a cell designated by the terminal 10 in advance. As the cell to always receive the paging is designated in the above manner, the paging does not need to be always received by all the cells broadcasting the system information about the cells used in carrier aggregation. Accordingly, the number of times the paging is received can be reduced.

When there is a notification of a modification to the system information about its own cell (when the system information modification is “on”), the terminal 10 receives the system information about its own cell. When there is a notification of a modification to the system information about another cell (the other cell modification is “on”), the terminal 10 receives the paging from a cell broadcasting the system information about the cells used in carrier aggregation. When there is a modification to the system information after checking as to whether there is a modification to the system information (whether there is a system information modification), the terminal 10 receives the system information (step S35). With such a check that is made to determine whether there is a modification to the system information through the paging, reception of the system information that is more likely to increase the data size than the paging is can be avoided, and power consumption can be reduced, when there is no modification to the system information.

FIG. 4 shows an example of operation in which the terminal 10 receives pagings from the base station 50. In the example shown in FIG. 4, the terminal 10 is performing carrier aggregation, using cell 1, cell 4, and cell 7. The cell 1 is used as a particular cell, and the paging is normally received from the cell 1. When receiving a paging indicating that the other cell modification is “on” from the cell 1 (action A41), the terminal 10 starts receiving pagings from the cell 4 and the cell 7 (action A42). Receiving a paging indicating that the system information modification is “off” from the cell 4 (action A43), the terminal determines not to receive the system information from the cell 4 (action A44). Through this operation, the number of times the terminal receives the system information that has not been modified can be reduced. When receiving a paging indicating that the system information modification is “on” during the paging reception from the cell 7 (action A45), the terminal 10 determines to receive the necessary system information from the cell 7 (action A46). The terminal 10 then receives the necessary system information broadcasted from the cell 7 (action A47).

The terminal may have the function to simultaneously receive pagings from cells (the cell 4 and the cell 7 in FIG. 4) broadcasting the system information about the cells used in the carrier aggregation. With this arrangement, the time required for the paging reception from the cells broadcasting the system information about the cells used in the carrier aggregation can be made shorter, and all the necessary pagings in the modification period can be received with a high probability. As a result, direct reception of the system information can be avoided by checking whether there is a modification to the system information. When there are no modifications to the system information, unnecessary reception of the system information can be avoided, and power consumption can be reduced.

### (Structure of the Terminal)

Referring now to FIG. 1, the structure of a terminal according to the first embodiment is described. The terminal 10 includes a receiving unit 110, a system information management unit 120, a paging management unit 130, and a control unit 140.

The receiving unit 110 has the function to receive pagings, system information, individual control information, and the like transmitted from the base station 50, in accordance with instructions sent from the control unit 140 and the like. The receiving unit 110 outputs pagings to the paging management unit 130, the system information to the system information management unit 120, and the individual control information to the control unit 140.

The system information management unit 120 manages the system information input from the receiving unit 110 by the cell. The system information management unit 120 determines whether the system information input from the receiving unit 110 is newer than the system information being managed in the system information management unit 120. If the input system information is newer than the system information being managed in the system information management unit 120, the system information management unit 120 updates the system information being managed. If the input system information is older than the system information being managed in the system information management unit 120, the system information management unit 120 does not modify the system information being managed.

After updating the system information being managed, the system information management unit 120 notifies the control unit 140 of the update. At this point, as the system information being managed has been updated, the system information management unit 120 may output the updated system information to the control unit 140. In this manner, the control unit 140 can recognize that the necessary information has been modified, and can use the updated system information.

When the control unit 140 issues a request to output the system information, the system information management unit 120 outputs the system information to the control unit 140. Based on the system information being managed and instructions from the control unit 140, the system information management unit 120 performs operations. For example, when the system information management unit 120 determines that the system information being managed has expired based on the period of validity of the system information broadcasted from the control unit 140, the system information management unit 120 determines that the system information needs to be updated, and requests an update of the system information from the control unit 140.

The paging management unit 130 manages pagings input from the receiving unit 110.

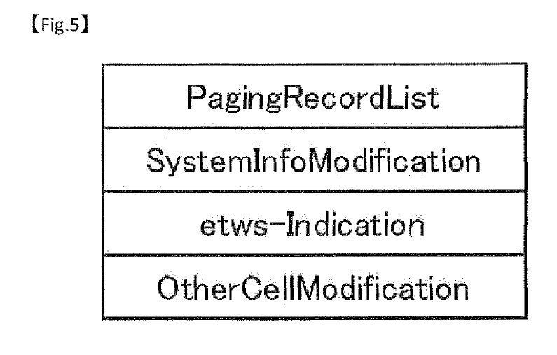

FIG. 5 is a diagram showing an example of format of a paging. A paging includes a paging record list (PagingRecordList), system information modification (SystemInfoModification), an etws-indication (etws-Indication), and other cell modification (OtherCellModification). The paging record list, the system information modification, and the etws-indication are the same as those of the conventional art.

In this embodiment, the other cell modification is added to a conventional paging. The other cell modification is the flag for indicating that a modification has been made to the system information in a cell (another cell) other than cells from which pagings have been received. The other cell modification is “on” where a modification has been made to the system information in another cell, and is “off” where no modifications have been made to the system information in other cells.

Referring back to FIG. 1, the paging management unit 130 includes an own-cell system information modification determining unit 131 and an other-cell system information modification determining unit 132.

Based on the system information modification in the paging received by the receiving unit 110, the own-cell system information modification determining unit 131 determines whether there is a modification to the system information about the cell from which the paging has been received. Based on the system information modification and the other cell modification in the paging received by the receiving unit 110, the other-cell system information modification determining unit 132 determines whether there is a modification to the system information about a cell other than the cell from which the paging has been received. If the system information modification in the input paging is “on,” the own-cell system information modification determining unit 131 notifies the control unit 140 that a modification has been made to the system information about the cell from which the paging has been received.

If the other cell modification in the input paging is “on,” and there is a cell from which a paging has not been received among the cells broadcasting the system information about the cells used in carrier aggregation, the other-cell system information modification determining unit 132 requests the control unit 140 for reception of the paging from the cell from which a paging has not been received among the cells broadcasting the system information about the cells used in the carrier aggregation.

If the system information modification in the input paging is “off” while the other cell modification in the input paging is “off,” and there is a cell from which a paging has not been received among the cells broadcasting the system information about the cells used in carrier aggregation, the other-cell system information modification determining unit 132 requests the control unit 140 for reception of the system information about the cell from which a paging has not been received among the cells broadcasting the system information about the cells used in the carrier aggregation.

If the system information modification in the input paging is “on” while the other cell modification in the input paging is “off,” and a request for reception of a paging about another cell has been sent to the control unit 140, the other-cell system information modification determining unit 132 requests the control unit 140 for a stop of the reception of the paging about another cell.

In a case where the paging management unit 130 receives the same paging containing the same system information modification and the same other cell modification twice or more from the same cell in the same modification period, the paging management unit 130 performs an operation in accordance with the contents of the system information modification and the other cell modification at the time of the first reception, but does not performs the operation in accordance with the contents of the system information modification and the other cell modification at the time of the second reception and later.

The control unit 140 controls the receiving unit 110 for receiving the paging from a particular cell among the cells corresponding to component carriers used in carrier aggregation. As described above, the particular cell is a cell designated by the base station 50 itself, or a cell designated by the terminal 10 in advance.

The control unit 140 controls the receiving unit 110 in accordance with the contents broadcasted from the other-cell system information modification determining unit 132 of the paging management unit 130. For example, in a case where there is a request from the other-cell system information modification determining unit 132 for reception of a paging about a cell from which a paging has not been received among the cells broadcasting the system information about the cells used in carrier aggregation, the control unit 140 controls the receiving unit 110 for receiving a paging about that cell. Also, in a case where there is a request for reception of the system information about a cell from which a paging has not been received among the cells broadcasting the system information about the cells used in carrier aggregation, for example, the control unit 140 controls the receiving unit 110 for receiving the system information about that cell. Also, in a case where there is a request for a stop of the reception of a paging about another cell, the control unit 140 controls the receiving unit 110 for stopping the reception of the paging about that cell.

In a case where the own-cell system information modification determining unit 131 of the paging management unit 130 notifies the control unit 140 of a modification to the system information about a cell from which a paging has been received, the control unit 140 controls the receiving unit 110 for receiving the system information about that cell.

As described above, in a case where a modification has been made to the system information in a cell from which a paging has not been received, the terminal 10 performing carrier aggregation can recognize the modification from the other cell modification contained in a paging, and receive the modified system information. That is, the terminal 10 performing carrier aggregation normally receives a paging about only one cell (a particular cell). Based on the paging received in the particular cell, the terminal 10 can recognize a modification to the system information about a cell from which a paging has not been received, and can obtain the information necessary for performing carrier aggregation. In this manner, the terminal 10 does not need to monitor pagings in all the cells involved in carrier aggregation, and can reduce power consumption.

Based on the contents of an input from the receiving unit 110, the paging management unit 130, or the system information management unit 120, the control unit 140 outputs broadcast schedule information (the broadcast cycles, the length of the time window, and the reception timing) regarding a paging or system information that needs to be received to the receiving unit 110, and instructs the receiving unit 110 to receive the corresponding information.

At this point, the control unit 140 requests necessary information from the system information management unit 120, and obtains the necessary information, such as the broadcast schedule information about system information. The control unit 140 also outputs the information necessary for managing system information to the system information management unit 120.

For example, there is a request from the paging management unit 130 for reception of the system information about a cell from which a paging has been received, the control unit 140 requests the receiving unit 110 to receive the system information from that cell. Also, when there is a request from the paging management unit 130 for reception of a paging about a cell that is broadcasting the system information about the cells used in carrier aggregation and has not confirmed a modification to the system information thereof, the control unit 140 requests the receiving unit 110 to receive a paging from that cell.

### (Structure of the Base Station)

FIG. 2 is a block diagram showing the structure of a base station according to the first embodiment. Referring to FIG. 2, the structure of the base station is described. The base station 50 includes a receiving unit 510, a system information management unit 520, a paging generating unit 530, a control unit 540, and a transmitting unit 550.

The receiving unit 510 receives system information or the like transmitted from a network (such as a MME (Mobility Management Entity)), and outputs the information to the control unit 540.

When the control unit 540 receives information regarding system information from a network or determines that a modification needs to be made to the system information, the control unit 540 outputs the information necessary for the modification about the cell having the system information to be modified among the cells under the base station 50, to the system information management unit 520.

In a case where a modification has been made to the system information about a cell under the base station 50, the control unit 540 outputs information indicating which cell has the modification made to the system information, to the paging generating unit 530.

At this point, the control unit 540 may have the function to output information indicating whether a modification has been made to the SIB (the SIB 2, for example) required for the terminal to maintain carrier aggregation in each cell, to the paging generating unit 530. Also, at this point, the control unit 540 may have the function to output information indicating whether a modification has been made to the information (the radio resource config common and the MBSFN subframe config list, for example) required for a terminal to maintain carrier aggregation in each cell, to the paging generating unit 530. In this manner, the paging generating unit 530 can have the function to generate a paging having the other cell modification set at “on” only in case where a modification has been made to the SIB required for the terminal 10 to maintain carrier aggregation or to the information required for the terminal 10 to maintain carrier aggregation. Accordingly, the number of receptions of the system information in which the information required by the terminal 10 has not been modified is made smaller, and power consumption can be reduced.

In a case where information about a modification to the system information is input from a network, the control unit 540 outputs the information to the paging generating unit 530. The control unit 540 outputs a notification containing the timing and an instruction to broadcast system information or to transmit a paging to the terminal, to the transmitting unit 550. If the control unit 540 does not hold the contents to report at this point, the control unit 540 requests the system information management unit 520 or the paging generating unit 530 to output for the necessary information.

Based on the contents input from the control unit 540, the system information management unit 520 manages system information to broadcast for each cell. In response to a request from the control unit 540, the system information management unit 520 outputs system information to the control unit 540.

Based on the contents input from the control unit 540, the paging generating unit 530 generates a paging. For example, when receiving a report of a modification to the system information about only one cell under the base station 50, the paging generating unit 530 generates a paging in which the system information modification is set at “on,” and the other cell modification is set at “off,” in that cell. For each of the other cells, the paging generating unit 530 generates a paging in which the system information modification is set at “off,” and the other cell modification is set at “on.” When receiving a report of modifications to the system information about more than one cell under the base station 50, the paging generating unit 530 generates a paging in which the system information modification is set at “on,” and the other cell modification is set at “on,” for each of the cells having the system information to be modified. For each of the other cells, the paging generating unit 530 generates a paging in which the system information modification is set at “off,” and the other cell modification is set at “on.”

In a case where the paging generating unit 530 receives information as to whether a modification has been made to the SIB required for the terminal 10 to maintain carrier aggregation or whether a modification has been made to the information required for the terminal 10 to maintain carrier aggregation, the paging generating unit 530 may have the function to determine to set the other cell modification at “on” or “off” from the above information. That is, in a case where the SIB required for the terminal 10 to maintain carrier aggregation is modified in a cell other than the particular cell, the paging generating unit 530 may generate a paging in which the other cell modification is set at “on,” and, in a case where the SIB required for the terminal 10 to maintain carrier aggregation is not modified in any cell other than the particular cell, the paging generating unit 530 may generate a paging in which the other cell modification is set at “off.” In a case where the information required for the terminal 10 to maintain carrier aggregation is modified in a cell other than the particular cell, the paging generating unit 530 may generate a paging in which the other cell modification is set at “on,” and, in a case where the information required for the terminal 10 to maintain carrier aggregation is not modified in any cell other than the particular cell, the paging generating unit 530 may generate a paging in which the other cell modification is set at “off.” In this manner, the probability that a paging having the other cell modification set at “off” is generated becomes higher. Accordingly, the number of times a paging about another cell is received becomes smaller, and power consumption can be reduced.

The paging generating unit 530 outputs each generated paging to the control unit 540.

According to an instruction from the control unit 540, the transmitting unit 550 transmits a paging and system information to the terminal 10.

### (Operations in the Wireless Communication System)

Operations to be performed in the wireless communication system having the above structure are now described, with reference to the accompanying drawings.

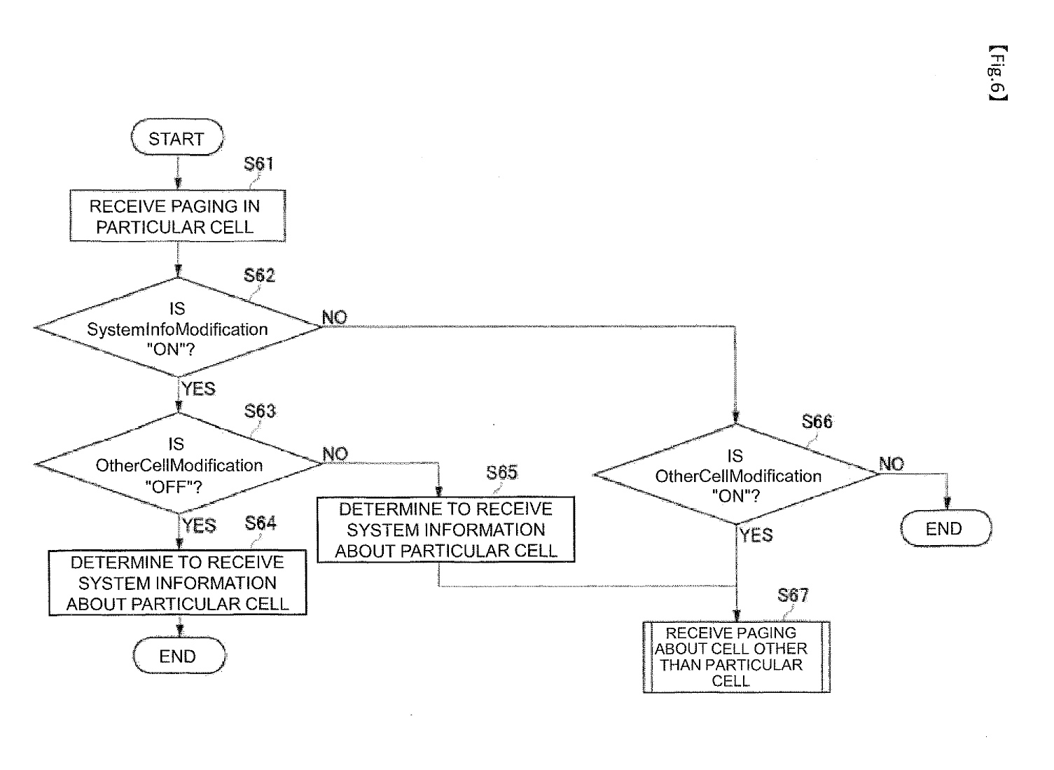

FIGS. 6 and 7 are flowcharts showing examples of operations to be performed by the terminal 10 of this embodiment.

FIG. 6 is a flowchart showing an operation to be performed by the terminal 10 after the terminal 10 receives a paging in the particular cell. The terminal 10 receives the paging transmitted from the base station 50, using a component carrier of the particular cell (step S61).

The terminal 10 then checks whether the system information modification in the paging received in the particular cell is “on” (step S62). If the system information modification is “on” in step S62 (YES in step S62), the terminal 10 checks whether the other cell modification in the paging received in the particular cell is “off” (step S63). If the other cell modification is “off” (YES in step S63), the terminal 10 determines to receive the system information about the particular cell (step S64), and ends the operation. If the other cell modification is “on” (NO in step S63), the terminal 10 determines to receive the system information about the particular cell (step S65), and moves on to the procedure (step S67) to receive a paging about another cell broadcasting the system information about the cells used in carrier aggregation.

If the system information modification in the paging about the particular cell is “off” in step S62 (NO instep S62), the terminal 10 checks whether the other cell modification is on (step S66). If the other cell modification is “on” (YES in step S66), the terminal 10 moves on to the procedure (step S67) to receive a paging about another cell broadcasting the system information about the cells used in the carrier aggregation. If the other cell modification is “off” (NO in step S66), the operation comes to an end.

FIG. 7 is a flowchart showing the operation to be performed by the terminal 10 to receive the paging about another cell broadcasting the system information about the cells used in the carrier aggregation. The terminal 10 receives the paging about another cell broadcasting the system information about the cells used in the carrier aggregation (step S71). The terminal 10 then checks whether the system information modification in the paging is “on” (step S72).

If the system information modification is “on” in step 72 (YES in step S72), the terminal 10 checks whether the other cell modification in the paging is “off” (step S73). If the other cell modification is “off” (YES in step S73), the terminal 10 determines to receive the system information about the cell from which the paging has been received (step S74), and ends the operation. If the other cell modification is “on” (NO in step S73), the terminal 10 determines to receive the system information about the cell from which the paging has been received (step S75), and checks whether the pagings about all the cells have been received (step S76).

If the system information modification is “off” in step S72 (NO in step S72), on the other hand, the terminal 10 checks whether the other cell modification is “on” (step S77). If the other cell modification is “on” (YES in step S77), the terminal 10 checks whether the pagings about all the cells have been received (step S76).

If the terminal 10 determines in step S76 that the pagings about all the cells have been received (YES in step S76), the terminal 10 ends the operation. If there is a cell about which a paging has not been received in step S76 (NO in step S76), the terminal 10 returns to step S71 to receive a paging about a cell that has not been confirmed among the other cells broadcasting the system information used in the carrier aggregation.

If the other cell modification is “off” in step S77 (NO in step S77), the terminal 10 receives the system information about all the cells not having a modification to the system information confirmed yet, and the system information about the cell from which the terminal 10 has determined to receive the system information in step 965 (see FIG. 6) or step S75, through pagings, among the cells broadcasting the system information about the cells used in the carrier aggregation (step S78).

After ending the operations shown in the flowcharts of FIGS. 6 and 7, the terminal 10 receives necessary cell system information in the next modification period. For example, in a case where the terminal 10 ends the operation after determining to receive the system information about the particular cell in step S64 of FIG. 6, the terminal 10 receives the system information about the particular cell in the next modification period. In a case where the terminal 10 ends the operation after determining to receive the system information about the cell from which the paging has been received in step S74 of FIG. 7, the terminal 10 receives the system information about the cell from which the terminal 10 determines to receive the system information in the next modification period. If the terminal 10 also has already determined to receive the system information about the particular cell in step S65 of FIG. 6, the terminal 10 also receives the system information about the particular cell in the next modification period. Further, in a case where the terminal 10 ends the operation after determining to have received the pagings about all the cells in step S76 of FIG. 7, the terminal 10 receives the system information about the cell from which the terminal 10 has determined to receive the system information in the next modification period, if the terminal 10 has already determined to receive the system information in step S75. If the terminal 10 also has determined to receive the system information about the particular cell in step S65 of FIG. 6, the terminal 10 receives the system information about the particular cell in the next modification period.

As in the above described flow, in a case where a paging about another cell is received (step S71), and the system information modification is “on” while the other cell modification is “off” (YES in step S73 after YES in step S72) as a result of a check on the paging, all the other cells having system information already modified have been checked. Therefore, in such a case, no more pagings about other unchecked cells are received, and the operation comes to an end. In this manner, reception of pagings about other cells not having system information modified can be omitted, and power consumption can be reduced.

As in the above described flow, in a case where a paging about another cell is received (step S71), and the other cell modification is “on” (NO in step S73, and YES in step S77) as a result of a check on the paging, a check is made to determine whether the pagings about all the cells have been received (step S76). In a case where the pagings about all the cells have already been received (YES in step S76), the operation comes to an end. In this manner, repetitive receptions of pagings in other cells are avoided, and the number of times a paging is received can be made smaller. In this manner, power consumption can be reduced.

As in the above described flow, in a case where a paging about another cell is received (step S71), and the system information modification is “off” while the other cell modification is also “off” (NO in step S77 after NO in step S72) as a result of a check on the paging, the result is inconsistent with the contents of the paging received in the particular cell. In this case, the paging received in another cell can be regarded as a paging received in a modification period different from the modification period in which the paging is received in the particular cell. That is, the next modification period has already started, and a check can no longer be made to determine whether there is a modification to the system information through some paging. Therefore, in such a case, actually required system information is received in all the unchecked cells (step S78), to determine whether there is a modification to the necessary system information.

Although not described in the above flow, the terminal 10 might receive a paging several times in the particular cell in one modification period. In such a case, if the contents of the system information modification and the other cell modification are the same between the first reception and the second and later receptions, the operation according to the above flow is not performed for the second and later receptions, and the operation comes to an end. In this manner, repetitive operations can be reduced. Accordingly, power consumption can be reduced.

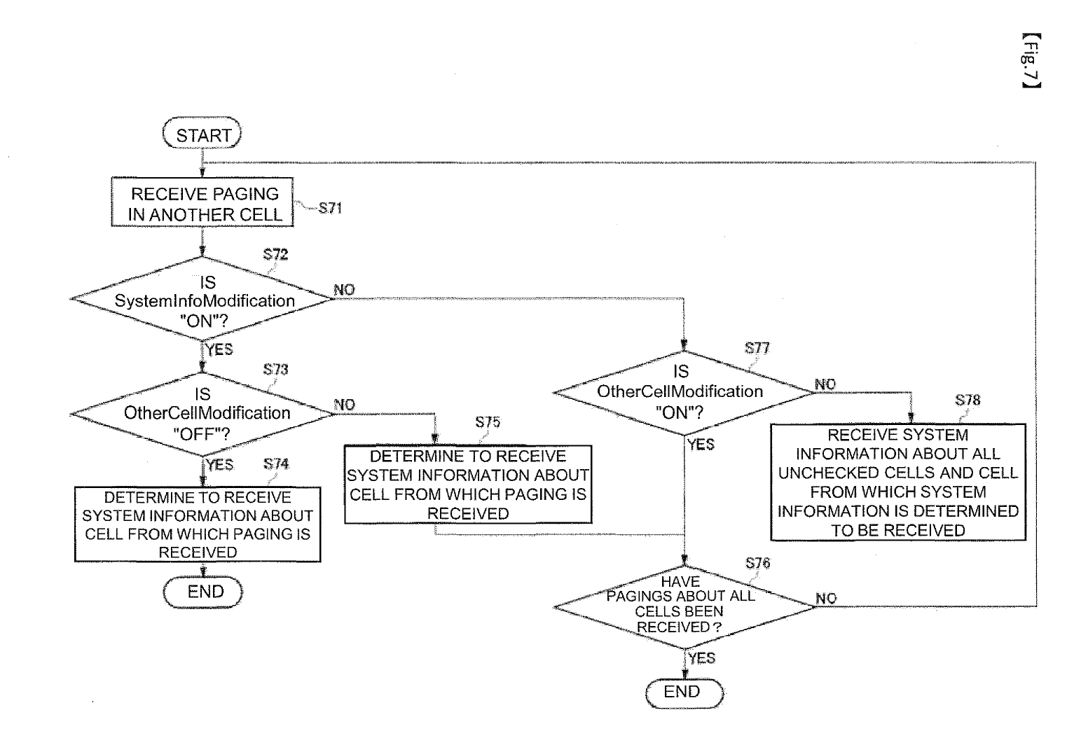

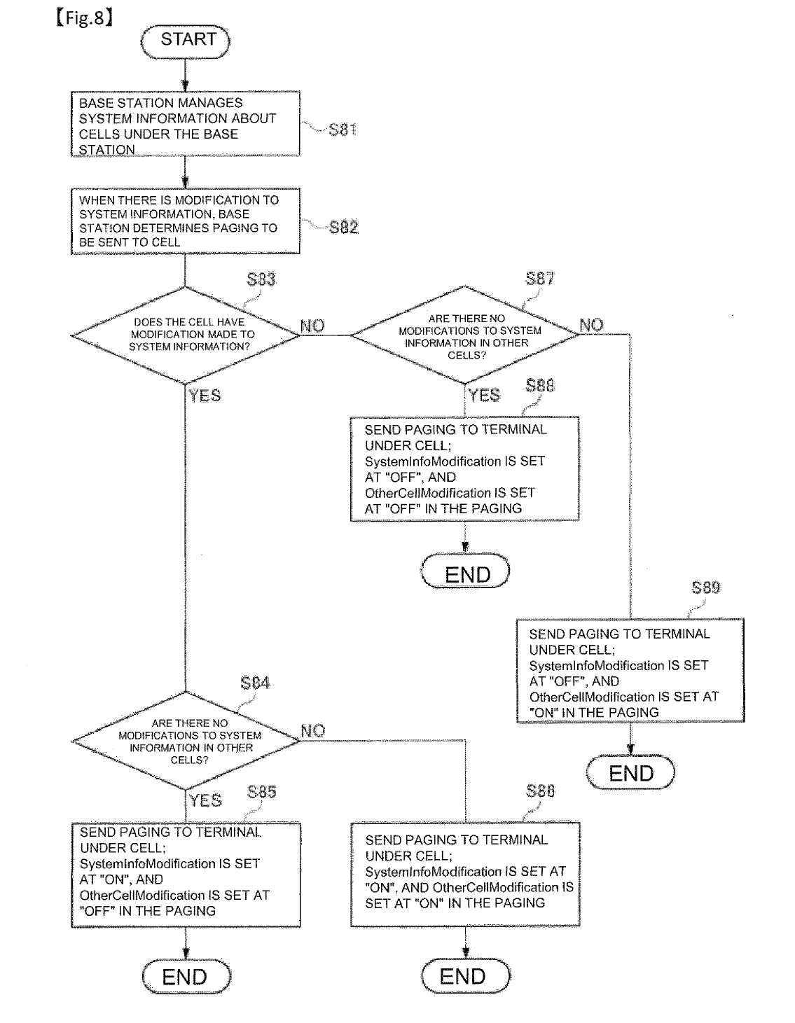

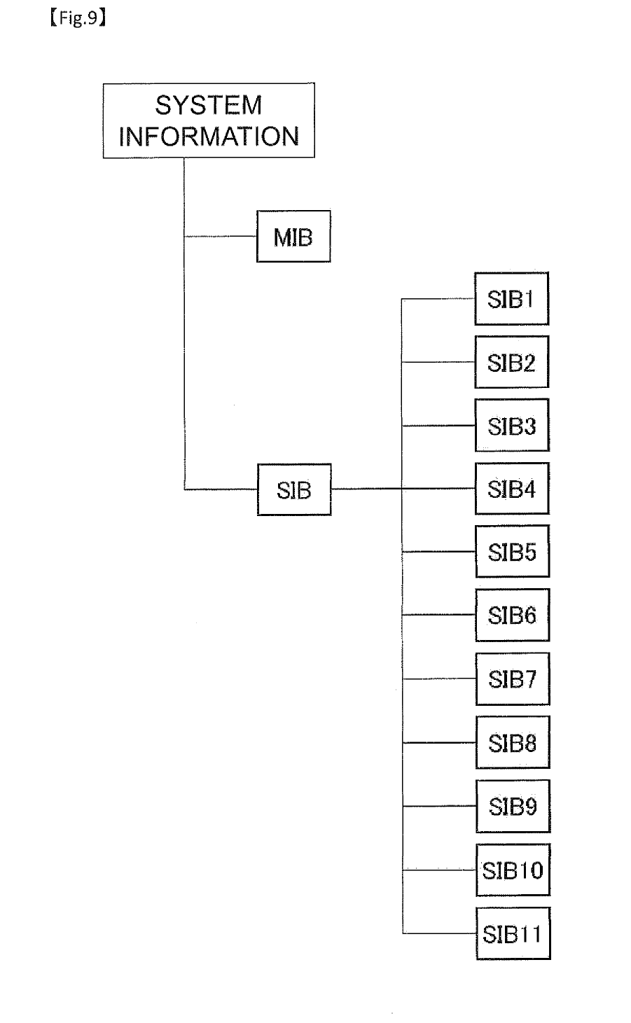

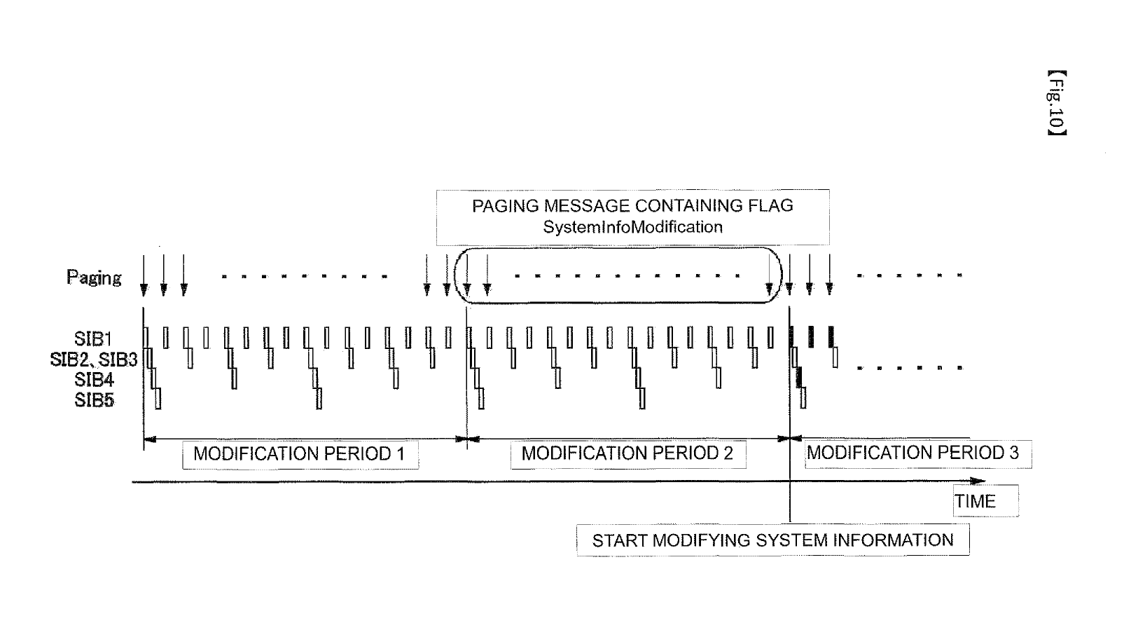

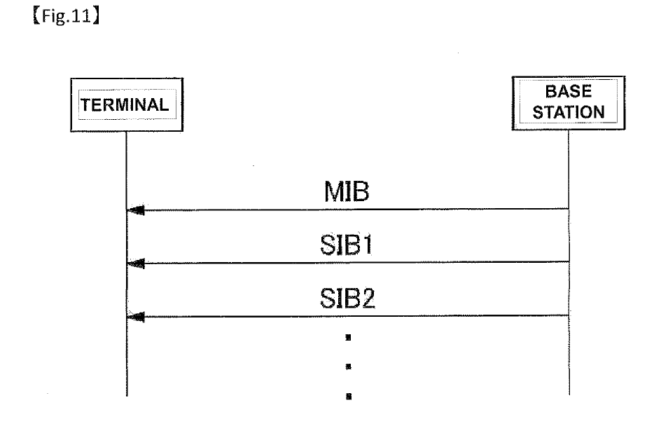

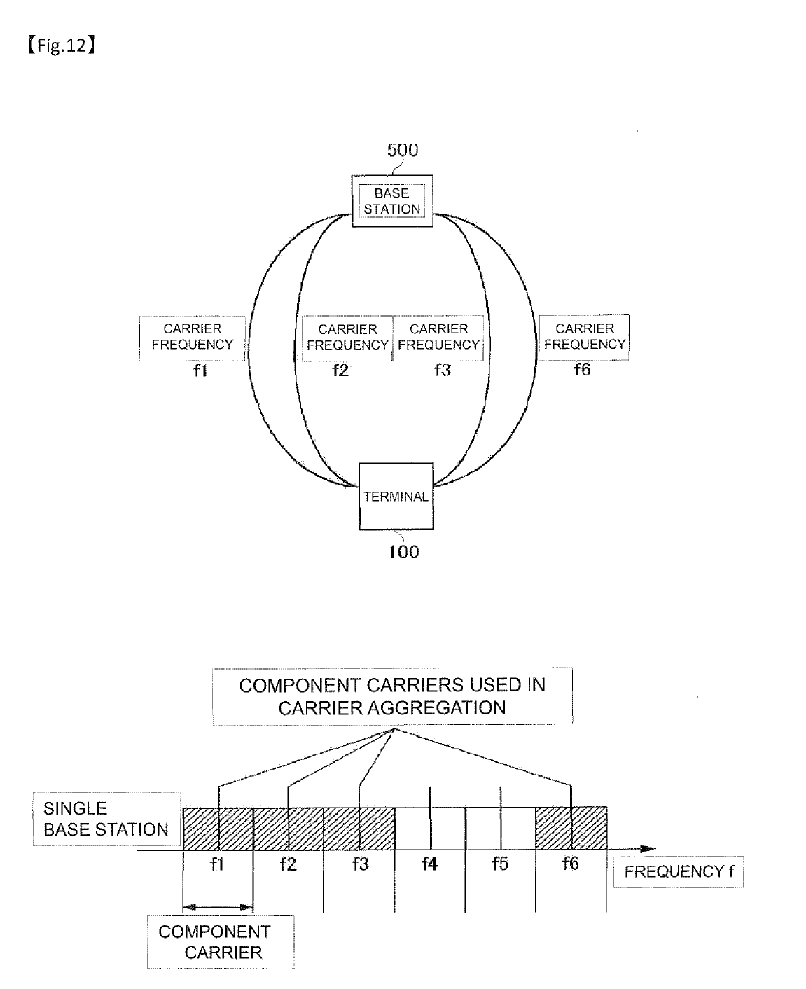

FIG. 8 is a flowchart showing an example of operation to be performed by the base station 50 of this embodiment to transmit a paging when system information is modified. The base station 50 manages the system information about the cells under the base station 50 (step S81). When there is a modification to the system information, the base station 50 determines a paging to be transmitted to the terminals under each of the cells broadcasting the system information (step S82). As for the cell having a modification made to the system information (YES in step S83), the base station 50 transmits a paging in which the system information modification is set at “on,” and the other cell modification is set at “off” to the terminals under that cell (step S85), if there are no modifications to the system information in the other cells (YES in step S84).

As for the cell having a modification made to the system information (YES in step S83), the base station 50 transmits a paging in which the system information modification is set at “on,” and the other cell modification is set at “on” to the terminals under that cell (step S86), if there is a modification to the system information in another cell (NO in step S84).

As for the cell having no modifications made to the system information (NO in step S83), the base station 50 transmits a paging in which the system information modification is set at “off,” and the other cell modification is set at “off” to the terminals under that cell (step S88), if there are no modifications to the system information in the other cells (YES in step S87).

As for the cell having no modifications made to the system information (NO in step S83), the base station transmits a paging in which the system information modification is set at “off,” and the other cell modification is set at “on” to the terminals under that cell (step S89), if there is a modification to the system information in another cell (NO in step S87).

As described above, in the wireless communication system of the first embodiment, at the time of carrier aggregation, a terminal receives a paging about only a particular cell among the cells broadcasting the system information about the cells used in the carrier aggregation. Based on the paging about the particular cell, the terminal checks whether the system information about other cells has been modified. Only when the system information about another cell is modified, does the terminal receive the paging about other cells. Accordingly, the power consumption required for reception of pagings can be dramatically reduced.

In this embodiment, when the base station 50 creates a paging for each cell, the other cell modification is set at “on” if the system information is partially modified in a cell other than the cell to which the paging is to be transmitted. However, the other cell modification may be set at “on” only in a case where the SIB broadcasting the information required for maintaining the carrier aggregation has been modified in a cell other than the cell to which the paging is to be transmitted. Accordingly, only in a case where the necessary SIB has been modified in a cell other than the cell to which the paging is to be transmitted, a terminal receives the paging about the other cell. Thus, the number of receptions of pagings in the cells other than the cell to which the paging is transmitted can be made even smaller, and the power consumption can be further reduced. For example, if carrier aggregation is performed only in a case where the terminal is in a connected state, the other cell modification is set at “on” only in a case where the SIB 2 has been modified.

Alternatively, the other cell modification may be set at “on” only in a case where the information necessary for maintaining the carrier aggregation has been modified in a cell other than the cell to which the paging is to be transmitted. In this manner, only in a case where the minimum necessary information has been modified in a cell other than the cell to which the paging is to be transmitted, the paging about the other cell is received. Accordingly, the number of receptions of pagings in the cells other than the cell to which the paging is to be transmitted can be made even smaller, and the power consumption can be further reduced. According to LTE, the other cell modification is set at “on” only in a case where modifications have been made to the radio resource config common containing the information that needs to be in synchronization with the base station to perform wireless communications, such as each channel setting, the uplink power control information, and the cyclic prefix length, and to the MBSFN-subframe config list to be used mainly for receiving services such as MBMS services and Relay services. In this manner, only in a case where the minimum information necessary for receiving the information and services necessary for performing wireless communications has been modified in a cell other than the cell to which the paging is to be transmitted, the paging about the other cell is received. Accordingly, the number of receptions of pagings in the cells other than the cell to which the paging is to be transmitted can be made even smaller, and the power consumption can be further reduced.

It should be noted that the above described paging format is merely an example, and some other paging format may be used. For example, by using a different P-RNTI, another paging format may be used, instead of an extended conventional paging format. Alternatively, a paging format indicating only the other cell modification is “on” or “off” may be used, for example. In such a case, a terminal may perform an operation that is to be performed after the system information is determined to be “off.”

### Second Embodiment

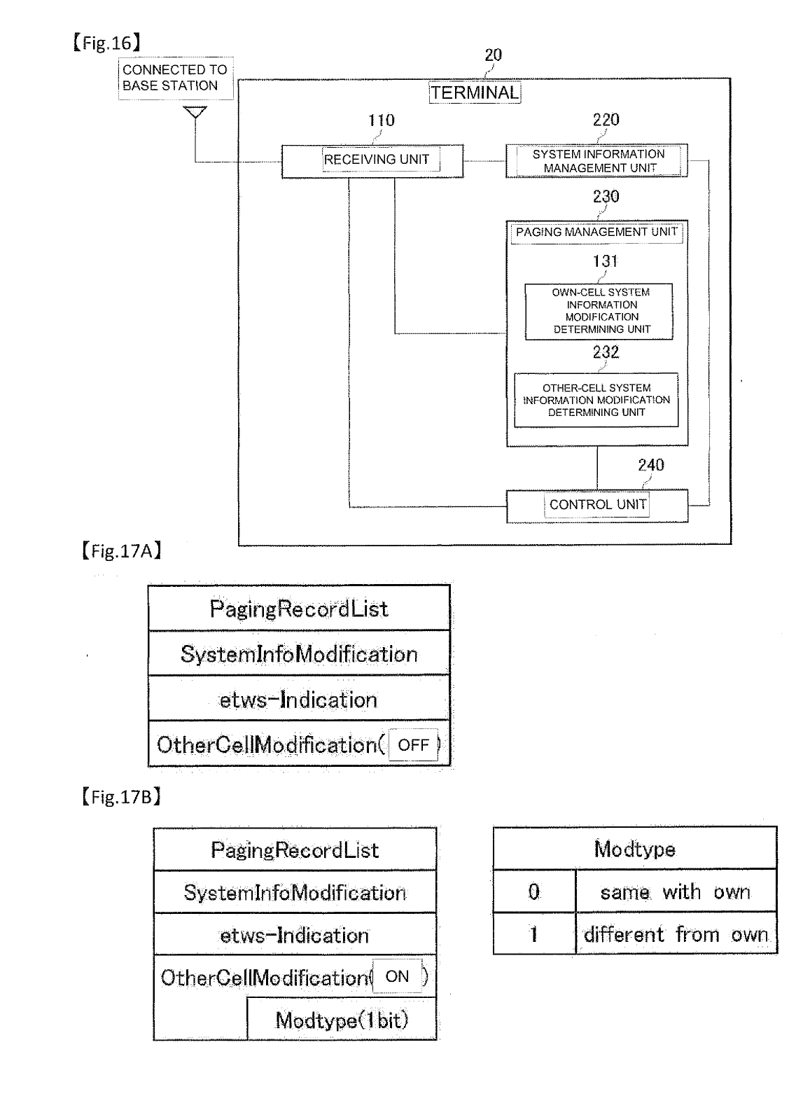

Referring now to FIGS. 16 through 19, a wireless communication system according to a second embodiment of the present invention is described. The wireless communication system according to the second embodiment of the present invention includes a terminal 20 and a base station 60.

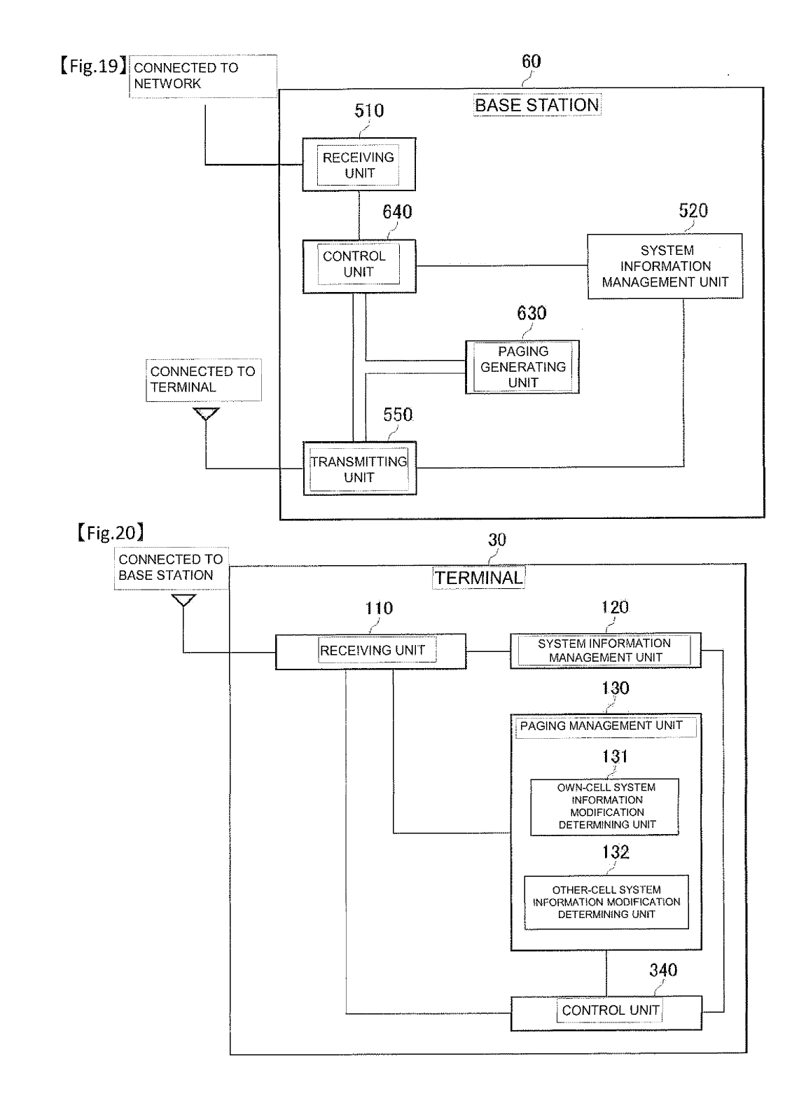

FIG. 16 is a block diagram showing the structure of the terminal 20 of this embodiment. FIG. 19 is a block diagram showing the structure of the base station 60 of this embodiment. In the wireless communication system according to this embodiment, the base station 60 allocates and manages radio resources (such as frequency bands in frequency domains or time domains), and serves as an access point in a wireless access network for the terminal 20. The terminal 20 receives a signal transmitted from the base station 60 via a downlink.

In the wireless communication system of this embodiment described below, the paging about the particular cell contains information indicating whether modifications to the system information about the other cells are the same as the modification to the system information about the particular cell. With this arrangement, the number of times the terminal receives a paging about another cell can be made even smaller than that in the above described first embodiment.

### (Structure of the Terminal)

Referring now to FIG. 16, the structure of the terminal 20 of this embodiment is described. The terminal 20 differs from the terminal 10 of the first embodiment in the structures of a system information management unit 220, a paging management unit 230, and a control unit 240. Therefore, the same components as those of the terminal 10 of the first embodiment are denoted by the same reference numerals as those used in the first embodiment, and detailed explanation for them is omitted herein.

The terminal 20 includes the receiving unit 110, the system information management unit 220, the paging management unit 230, and the control unit 240.

In addition to the function of the system information management unit 120 of the first embodiment, the system information management unit 220 has the function to perform an operation by following an instruction issued from the control unit 240 to update part of the system information about a cell in the same manner as an update made to the contents of the system information about another cell. In this manner, the system information can be updated in the terminal 20. For example, in a case where the system information management unit 220 manages the system information about cell 1 and cell 4, when there is an update to the system information about the cell 1, and the system information about the cell 4 should be modified in the same manner as the modification to the system information about the cell 1, the terminal 20 simply has to receive the system information about the cell 1, and the system information about the cell 4 can be updated by using the updated system information about the cell 1. When the contents of an update are broadcasted from the control unit 240, the system information management unit 220 performs an operation according to the instruction.

The paging management unit 230 manages pagings input from the receiving unit 110.

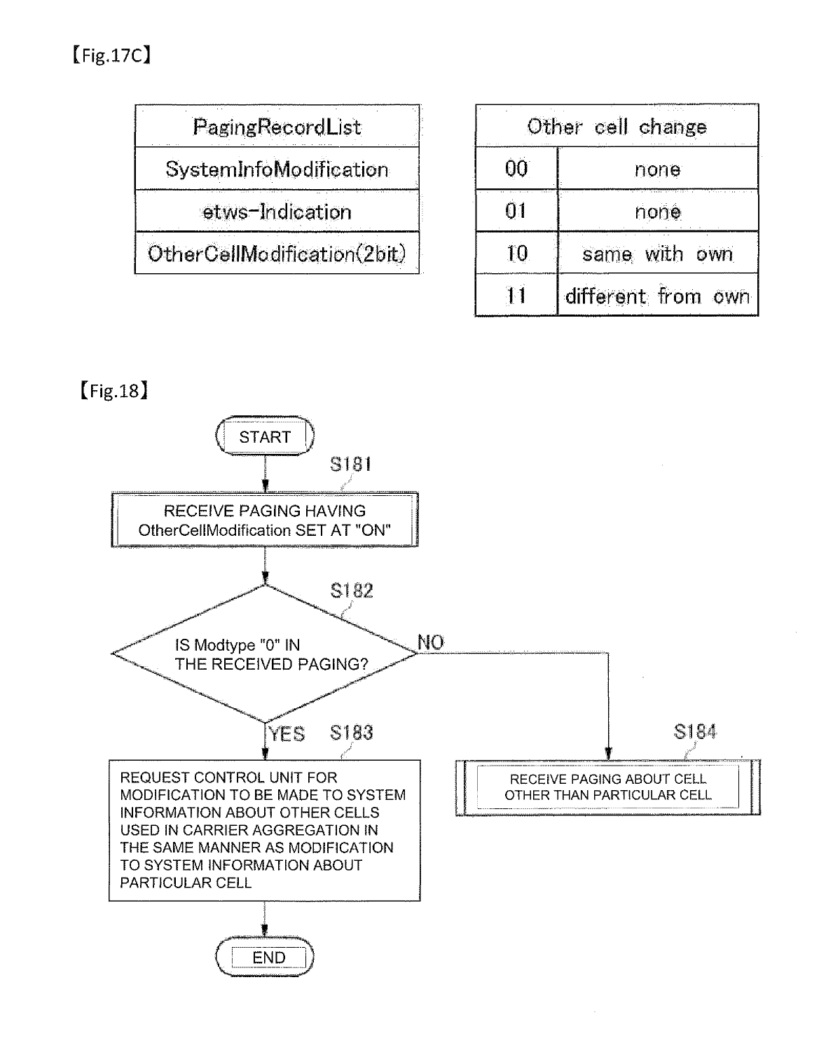

FIG. 17 are a diagram showing examples of paging formats according to this embodiment. FIG. 17A shows a paging format to be used when the other cell modification is “off.” FIG. 17B shows a paging format to be used when the other cell modification is “on. “In a case where the other cell modification is “off,” the terminal 20 performs the same operation as that in the first embodiment.

In a case where the other cell modification is “on,” 1-bit “mod type” is added to the other cell modification in the paging message. This mod type is the information indicating whether modifications to the system information about the other cells are the same as a modification to the system information about a cell (the particular cell) that has received the paging.

When the mod type is “0,” the system information about all the cells has been modified in the same manner as the modification to the system information in the particular cell. When the mod type is “1,” the system information about some or all of the other cells has been modified in a different manner from the modification to the system information in the particular cell. Accordingly, when the mod type is “0,” the terminal 20 does not need to receive the paging about other cells, and, furthermore, does not need to receive the system information from other cells, either. Using the modified system information about the particular cell, the terminal 20 can modify the system information about the other cells.

FIG. 17C shows an example of a paging format indicative of whether there are modifications to the system information about the other cells, and whether the modifications to the system information about the other cells are the same as the modification to the system information about the particular cell. In the example shown in FIG. 17C, the other cell modification is expressed by 2 bits. In a case where the other cell modification is “00” or “01,” there are no modifications to the system information about the other cells.

In a case where the other cell modification is “10,” the system information about all the other cells has been modified in the same manner as the modification to the system information in the particular cell. In a case where the other cell modification is “11,” the system information about some or all of the other cells has been modified in a different manner from the modification to the system information in the particular cell. In this manner, the paging format can indicate whether the modifications to the system information about the other cells are the same as the modification to the system information about the particular cell as in the cases shown in FIGS. 17A and 17B, while the paging size is always the same. The above 2-bit allocation is merely an example, and some other allocation may be performed.

In the following, a case where the paging formats shown in FIGS. 17A and 17B are used is described.

The paging management unit 230 includes the own-cell system information modification determining unit 131 and an other-cell system information modification determining unit 232. The own-cell system information modification determining unit 131 performs the same operation as that in the first embodiment, and therefore, explanation thereof is omitted here. Also, the operation to be performed by the other-cell system information modification determining unit 232 when a paging having the other cell modification set at “off” is received is the same as that in the first embodiment, and therefore, explanation thereof is omitted here.

FIG. 18 is a flowchart for explaining operations in the terminal 20. Referring to FIG. 18, the operation to be performed by the other-cell system information modification determining unit 232 when a paging having the other cell modification set at “on” is received is described. Receiving a paging having the other cell modification set at “on” in the particular cell (step S181), the other-cell system information modification determining unit 232 checks whether the mod type is “0” (step S182). If the mod type is “0” (YES in step S182), the other-cell system information modification determining unit 232 requests the control unit 240 for modifications to the system information about the other cells broadcasting the system information about the cells used in carrier aggregation in the same manner as the modification to the system information about the particular cell (step S183).

If the mod type is “1” (NO in step S182), the other-cell system information modification determining unit 230 requests the control unit 240 for reception of a paging in another cell broadcasting the system information about the cells used in the carrier aggregation (step S184). The procedures for receiving a paging in another cell broadcasting the system information about the cells used in the carrier aggregation are the same as those procedures in the first embodiment illustrated in FIG. 7.

As described above, in a case where a modification to the system information about the particular cell is the same as modifications to the system information about all the other cells, that is, by the presence of a case of where the mod type is “0,” at the time of carrier aggregation, the number of receptions of pagings about the other cells used in the carrier aggregation can be made smaller, and power consumption can be reduced.

In addition to the function of the control unit 140 of the first embodiment, the control unit 240 has the following function. Receiving a request for modifications to the system information about the other cells used in carrier aggregation in the same manner as the modification to the system information about the particular cell, the control unit 240 checks whether the modified system information has been received in the particular cell. The control unit 240 then instructs the system information management unit 220 to modify the system information about the other cells used in the carrier aggregation in the same manner as the modification to the system information about the particular cell. In this manner, at the time of carrier aggregation, the number of receptions of pagings or system information about the other cells used in the carrier aggregation can be made smaller, and power consumption can be reduced.

In a case where an instruction is issued to modify the system information about the other cells to have the same contents as the updated system information about the particular cell does, the base station 60 determines which information to modify in accordance with a policy for creating a paging. For example, in a case where the SIB 2 is modified in the same manner among all the cells under the base station 60, when a paging having the mod type set at “0” is created, the control unit 240 of the terminal 20 receives a paging in which the other cell modification is set at “on,” and the mod type is set at “0.” Based on the updated SIB 2 received in the particular cell, the control unit 240 instructs the system information management unit 220 to update the SIB 2 in each of the other cells.

Also, in a case where the radio resource config common and the MBSFN subframe config list are modified in the same manner among all the cells under the base station 60, for example, when a paging having the mod type set at “0” is created, the control unit 240 of the terminal 20 receives a paging in which the other cell modification is set at “on,” and the mod type is set at “0.” Based on the updated radio resource config common and MBSFN subframe config list received in the particular cell, the control unit 240 instructs the system information management unit 220 to update the radio resource config common and MBSFN subframe config list in each of the other cells.

As described above, the other cell modification is set at “on” only in a case where the information necessary for maintaining carrier aggregation has been modified. In this manner, the number of times a paging is received in the other cells can be made smaller, and the power consumption can be reduced. Further, as the object of the mod type is narrowed in the same manner as the other cell modification, the number of times the mod type indicates “0” becomes larger. Accordingly, the number of times a paging about another cell is received can be made even smaller, and the power consumption can be further reduced.

### (Structure of the Base Station)

FIG. 19 is a block diagram showing the structure of the base station 60 of the second embodiment. Referring to FIG. 19, the structure of the base station 60 is described. The base station 60 differs from the base station 50 of the first embodiment in the structures of a paging generating unit 630 and a control unit 640. Therefore, the same components as those of the base station 50 of the first embodiment are denoted by the same reference numerals as those used in the first embodiment, and detailed explanation for them is omitted herein.

The base station 60 includes the receiving unit 510, the system information management unit 520, the paging generating unit 630, the control unit 640, and the transmitting unit 550.

In addition to the function of the control unit 540 of the first embodiment, the control unit 640 has the following function. When the system information is input, the control unit 640 outputs to the paging generating unit 630 the information indicating whether the system information about all the cells under the base station 60 is to be modified in the same manner or the system information is to be modified in a different manner in some of the cells.

Instead of the above information, the control unit 640 may output to the paging generating unit 630 the information indicating whether the SIB (such as the SIB 2) required for maintaining carrier aggregation is to be modified in the same manner among all the cells under the base station 60 or the SIB is to be modified in a different manner in some of the cells. Alternatively, the control unit 640 may output to the paging generating unit 630 the information indicating whether the radio resource config common and the MBSFN subframe config list, as the information necessary for maintaining carrier aggregation, are to be modified in the same manner among all the cells under the base station 60 or the radio resource config common and the MBSFN subframe config list are to be modified in a different manner in some of the cells.

In addition to the function of the paging generating unit 530 of the first embodiment, the paging generating unit 630 has the function to generate a paging based on the information input from the control unit 640. That is, receiving from the control unit 640 the information indicating that there are no modifications to the system information about the cells other than the particular cell, the paging generating unit 630 generates a paging message having the other cell modification set at “off.”

Receiving from the control unit 640 the information indicating that the system information about all the cells under the base station 60 is to be modified in the same manner, the paging generating unit 630 generates a paging in which the other cell modification is set at “on,” and the mod type is set at “0.” Receiving from the control unit 640 the information indicating that the system information is to be modified in a different manner in some of the cells, the paging generating unit 630 generates a paging in which the other cell modification is set at “on,” and the mod type is set at “1.”

As described above, in the wireless communication system of the second embodiment, each paging contains the information indicating whether the system information about the cells other than the particular cells has been modified in the same manner as the system information about the particular cell has. In a case where the system information about the other cells has been modified in the same manner as the modification to the system information about the particular cell has, the terminal does not receive a paging nor system information about other cells, and modifies the system information about the other cells in the same manner as the modification to the system information about the particular cell. In this manner, reception of pagings and system information about the other cells can be omitted, and power consumption can be reduced.

When information indicating that the SIB (such as the SIB 2) necessary for maintaining carrier aggregation is to be modified in a different manner in some of the cells under the base station 60 is reported together with information indicating that system information is modified in two or more of the cells under the base station 60 and indicating which cells have system information to be modified, the paging generating unit 630 may generate a paging in which the other cell modification is set at “on,” and the mod type is set at “1.” Also, when there is reported information indicating that the SIB reporting the information necessary for maintaining the carrier aggregation is modified in each of the other cells in the same manner as in the cell to which a paging is to be transmitted, the paging generating unit 630 may have a function to generate a paging having the mod type set at “0.” That is, when there is reported information indicating that the SIB (such as the SIB 2) necessary for maintaining the carrier aggregation is to be modified in the same manner among all the cells under the base station 60 or that the SIB is to be modified in a different manner in some of the cells, the paging generating unit 630 may determine the mod type based on the reported information. Accordingly, the number of times the mod type indicates “0” becomes larger. In this manner, the number of receptions of a paging can be made even smaller, and the power consumption can be further reduced.

Alternatively, as for the information necessary for maintaining the carrier aggregation, when there is reported information indicating that the radio resource config common as the information necessary for maintaining wireless communications and the MBSFN subframe config list necessary for receiving MBMS services and the like are to be modified in the same manner among all the cells under the base station 60 or that the radio resource config common and the MBSFN subframe config list are to be modified in a different manner in some of the cells, the paging generating unit 630 may have a function to determine the mod type or the 2-bit other cell modification based on the reported information. Accordingly, the number of times the mod type indicates “0” becomes larger. In this manner, the number of paging receptions can be made even smaller, and the power consumption can be further reduced.

It should be noted that the above described paging formats are merely examples, and some other paging formats may be used. For example, by using a different P-RNTI, some other paging format may be used, instead of an extended conventional paging format. Alternatively, a paging format indicating only the other cell modification is “on” or “off” may be used, for example. In such a case, a terminal may perform an operation that is to be performed after the system information is determined to be “off.”

### Third Embodiment

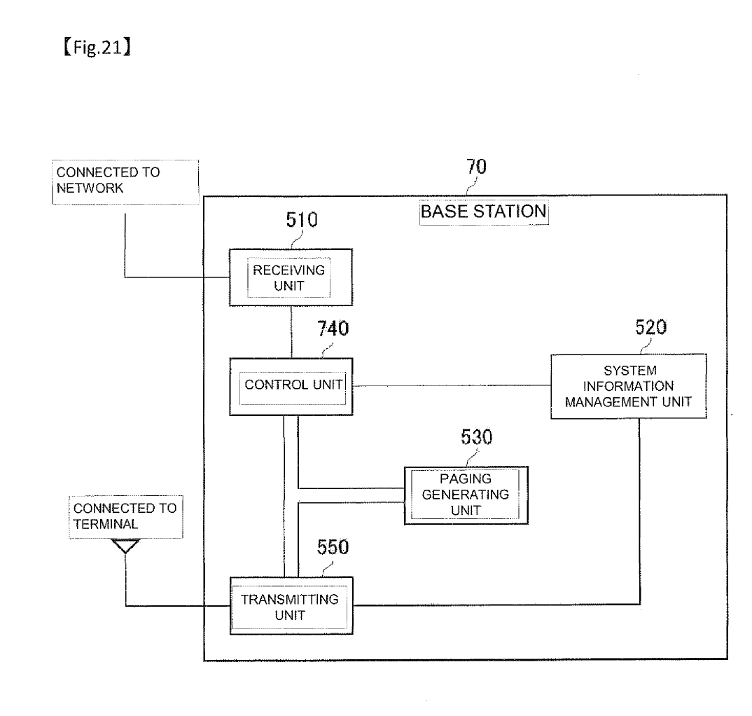

Referring now to FIGS. 20 and 21, a wireless communication system according to a third embodiment of the present invention is described. The wireless communication system according to the third embodiment of the present invention includes a terminal 30 and a base station 70.

FIG. 20 is a block diagram showing the structure of the terminal 30 of this embodiment. FIG. 21 is a block diagram showing the structure of the base station of this embodiment. In the wireless communication system according to this embodiment, the base station 70 allocates and manages radio resources (such as frequency bands in frequency domains or time domains), and serves as an access point in a wireless access network for the terminal 30. The terminal 30 receives a signal transmitted from the base station 70 via a downlink.

In the wireless communication system of this embodiment described below, pagings and system information can be received from cells that are not used in carrier aggregation, so that the degree of freedom in carrier frequencies the terminal 30 can use for the carrier aggregation can be made higher.

In the wireless communication system of this embodiment, cells that broadcast system information coexist with cells that do not broadcast system information, and the cells not used in the carrier aggregation broadcast the cell-specific system information about the cells used in the carrier aggregation, as illustrated in FIG. 15C.

In the following description, a cell that is used in the carrier aggregation but does not broadcast the system information, and receives the system information broadcasted from another cell not used in the carrier aggregation is referred to as a “non-broadcasting cell.” A cell that broadcasts the system information about the non-broadcasting cell on behalf of the non-broadcasting cell and is not used in the carrier aggregation is referred to as a “surrogate broadcasting cell.”

The terminal 30 and the base station 70 each hold a paging reception timing determining method for determining beforehand the timing to receive a paging in a cell not used in the carrier aggregation, based on a terminal ID or the like. The paging reception timing determining method held by the terminal 30 is the same as the paging reception timing determining method held by the base station 70.

When transmitting a paging having the other cell modification set at “on” to the terminal 30, the base station 70 determines whether the terminal 30 is receiving system information from a surrogate broadcasting cell. If the base station 70 determines that the terminal 30 is receiving a paging from a surrogate broadcasting cell, the base station 70 calculates the timing to receive the paging by using the paging reception timing determining method. The base station 70 suspends data transmission to a non-broadcasting cell according to the timing when the terminal 30 receives the paging. If the terminal 30 later determines that it is necessary to receive the system information from the surrogate broadcasting cell, the base station 70 suspends data transmission to the non-broadcasting cell according to the timing when the surrogate broadcasting cell broadcasts the system information.

Receiving a paging having the other cell modification set at “on” from the base station 70, the terminal 30 receives a paging from the surrogate broadcasting cell. At this point, the terminal 30 calculates the timing to receive a paging by the paging reception timing determining method, and sets an interval period for the non-broadcasting cell in accordance with the timing. During this interval period, the terminal 30 switches from the non-broadcasting cell to the surrogate broadcasting cell, and receives a paging from the surrogate broadcasting cell. While not receiving a paging, the terminal 30 switches from the surrogate broadcasting cell to the non-broadcasting cell, and receives data. In this manner, the base station 70 does not need to transmit a signal to the terminal 30 when the terminal 30 switches between the non-broadcasting cell and the surrogate broadcasting cell, and can allocate the resource to another terminal while the terminal 30 is receiving a paging. Accordingly, the resources can be effectively used without an increase of transmission signals.

Receiving a paging having the system information modification set at on from a surrogate broadcasting cell, the terminal 30 receives system information in the surrogate broadcasting cell. When receiving the system information from the surrogate broadcasting cell, the terminal 30 switches from a non-broadcasting cell to the surrogate broadcasting cell, and then receives the system information from the surrogate broadcasting cell. At this point, the terminal 30 can not necessarily receive the system information through one attempt of reception. Therefore, the base station 70 determines how many times the terminal 30 is to attempt to receive the system information in synchronization with the broadcast cycles, with the radio-wave condition of the terminal 30 being taken into consideration. The base station 70 then determines the period of data transmission suspension. In this manner, the resource can be allocated to another terminal while the terminal 30 is receiving the system information. Accordingly, the resources can be effectively used without an increase of transmission signals.

An example of operation to be performed by the terminal 30 of this embodiment is now described. An example case where the terminal 30 performs carrier aggregation using the cells A, A′, and B′ shown in FIG. 15C is described. In this case, the cell B′ is a non-broadcasting cell, and a cell that acts for broadcasting the system information about the non-broadcasting cell B′ is the surrogate broadcasting cell B. In this example, a particular cell is the cell A.

In a case where the other cell modification is “on” in a paging received from the cell A, the terminal 30 checks whether there is a modification to the system information about the other cells used in the carrier aggregation (that is, the cell A′ and the cell B′). Since the cell A is broadcasting the cell-specific information about the cell A′, the terminal 30 receives the system information from the cell A if the system information modification is “on” in the paging from the cell A. Since the cell B is broadcasting the cell-specific information about the cell B′, the terminal 30 receives a paging from the cell B, and checks whether there is a modification to the system information about the cell B′. To receive the paging from the cell B, the terminal 30 calculates the timing to receive the paging based on the terminal ID or the like, and sets an interval period for the cell B′ in accordance with the timing. During the interval period, the terminal 30 switches from the cell B′ to the cell B, and receives the paging from the cell B. If the system information modification is “on” in the paging received from the cell B, the terminal 30 switches from the cell B′ to the cell B, and receives the system information.

### (Structure of the Terminal)

Referring now to FIG. 20, the structure of the terminal 30 of this embodiment is described. The terminal 30 differs from the terminal 10 of the first embodiment in the structure of a control unit 340. Therefore, the same components as those of the terminal 10 of the first embodiment are denoted by the same reference numerals as those used in the first embodiment, and detailed explanation for them is omitted herein.

The terminal 30 includes the receiving unit 110, the system information management unit 120, the paging management unit 130, and the control unit 340.

In addition to the function of the control unit 140 of the first embodiment, the control unit 340 has the following function. When the paging management unit 130 issues a request to receive a paging from a cell not used in carrier aggregation (or from a surrogate broadcasting cell), the control unit 340 calculates the timing to receive the paging, based on the terminal ID or the like. The control unit 340 then sets an interval period in accordance with the timing. During the interval period, the control unit 340 switches from a non-broadcasting cell to the surrogate broadcasting cell, and instructs the receiving unit 110 to receive the paging from the surrogate broadcasting cell.

When the paging management unit 130 issues a request to receive system information from a cell not used in the carrier aggregation (or from a surrogate broadcasting cell), the control unit 340 switches from a non-broadcasting cell to the surrogate broadcasting cell, and instructs the receiving unit 110 to receive the system information from the surrogate broadcasting cell.

A method of calculating the timing (or interval period) to receive a paging based on a terminal ID or the like is now described. At present, Non-Patent Literature 2 discloses the timing for a terminal performing DRX (Discontinuous Reception) to receive a paging. In this embodiment, the method for replacing the IMSI (International Mobile Subscriber Identity) used in this method with a C-RNTI (Cell Radio Network Temporary Identifier) is described. The terminal determines the paging frame (PF) to receive a paging, according to the following equation 1:

SFN mod T=(T div N)*(UE_{—}ID mod N) (equation 1)

Here, SFN represents the system frame number. T represents the DRX period of the terminal. As the DRX period, a default value given in system information or the terminal-specific value is used. In a case where the terminal-specific value is used, the base station can recognize the DRX period of the terminal, since the base station also knows that the terminal-specific value is used as the DRX period. The default value of the DRX is contained in the radio resource config common, and the terminal-specific value of the DRX is individually sent via a network. N is expressed by the following equation 2:

N=min(T,nB) (equation 2)

That is, N is T or nB, whichever is smaller. nB is contained in the radio resource config common. UB_ID represents the terminal ID, and is expressed by the following equation 3:

UE_{—}ID=C-RNTI mod 1024 (equation 3)

Which subframe in a paging frame determined in the above manner is to receive a paging varies between a FDD (Frequency Division Duplex) system and a TDD (Time Division Duplex) system, and a computable table containing parameters i_s and Ns is held in advance. i_s and Ns are expressed by the following equations 4 and 5, respectively:

i_{—}s=floor(UE_{—}ID/N)mod Ns (equation 4)

Ns=max(1,nB/T) (equation 5)

A case of a FDD system is described. When Ns is “1,” i_s is “0,” and the terminal receives a paging at subframe number 9. When Ns is “2,” i_s is “0” or “1.” When i_s is “0,” the terminal receives a paging at subframe number 4. When i_s is “1,” the terminal receives a paging at subframe number 9. When Ns is “4,” i_s is “0”, “1”, “2”, or “3.” When i_s is “0,” the terminal receives a paging at subframe number 0. When i_s is “1,” the terminal receives a paging at subframe number 4. When i_s is “2,” the terminal receives a paging at subframe number 5. When i_s is “3,” the terminal receives a paging at subframe number 9.

A case of a TDD system is now described. When Ns is “1,” i_s is “0,” and the terminal receives a paging at subframe number 0. When Ns is “2,” is “0” or “1.” When i_s is “0,” the terminal receives a paging at subframe number 0. When i_s is “1,” the terminal receives a paging at subframe number 5. When Ns is “4,” i_s is “0”, “1”, “2”, or “3.” When i_s is “0,” the terminal receives a paging at subframe number 0. When i_s is “1,” the terminal receives a paging at subframe number 1. When i_s is “2,” the terminal receives a paging at subframe number 5. When i_s is “3,” the terminal receives a paging at subframe number 6.

In the above description, the terminal ID is replaced with a C-RNTI. However, the terminal ID may be replaced with an S-TMSI (SAE Temporary Mobile Subscriber Identity). Alternatively, any ID that can be recognized by both the terminal and the base station may be used.

The IMSI in Non-Patent Literature 2 is replaced with a C-RNTI (Cell Radio Network Temporary Identifier) or an S-TMSI (SAE Temporary Mobile Subscriber Identity), and the timing to receive a paging is then determined. In this manner, since the base station does not necessarily know the IMSI, the timing to receive a paging can be shared between the base station and the terminal without signal transmission.

### (Structure of the Base Station)

Referring now to FIG. 21, the structure of the base station 70 is described. The base station 70 differs from the base station 50 of the first embodiment in the structure of a control unit 740. Therefore, the same components as those of the base station 50 of the first embodiment are denoted by the same reference numerals as those used in the first embodiment, and detailed explanation for them is omitted herein.

The base station 70 includes the receiving unit 510, the system information management unit 520, the paging generating unit 530, the control unit 740, and the transmitting unit 550.

In addition to the function of the control unit 540 of the first embodiment, the control unit 740 has the following function. If there is a possibility that the terminal 30 that is receiving system information from a cell not used in carrier aggregation (or from a surrogate broadcasting cell) receives a paging having the other cell modification set at “on” at the time of paging reception, the control unit 740 calculates the timing for the terminal 30 to receive a paging from the surrogate broadcasting cell, based on the terminal ID or the like. During the calculated time period, the control unit 740 performs scheduling so as to stop data transmission to the cell (that is, a non-broadcasting cell) that becomes unable to receive data because the terminal 30 switches connections, and outputs the result of the scheduling to the transmitting unit 550.

Since the control unit 740 knows which cells are used in the carrier aggregation by the terminal 30, the control unit 740 can determine from which cell not used in the carrier aggregation the system information is to be received. After determining that the system information is to be received from a surrogate broadcasting cell, the control unit 740 performs scheduling so as to stop data transmission to the non-broadcasting cell while the system information to be received by the terminal 30 is being broadcasted. The control unit 740 then outputs the result of the scheduling to the transmitting unit 550.

As described above, in this embodiment, the terminal and the base station use the same paging reception timing determining method, and the timing to receive a paging is determined based on the identification information about the terminal. Accordingly, the base station and the terminal can set the same timing to receive a paging, even though the base station does not notify the terminal of the timing to receive a paging. While the influence on communications from the other cells used in carrier aggregation is reduced, a paging message can be received from a cell that is not used in the carrier aggregation.

In this embodiment, illustrated are examples in which functions are added to those of the first embodiment. However, the above described functions may also be added to those of the second embodiment.

In the above described first through third embodiments, the base stations 50, 60, and 70 are described as wireless base stations. However, the present invention can also be applied to relay nodes, home wireless base stations, CSGs, and the like.

In the above described first through third embodiments, when a terminal receives a paging having the other cell modification set at “on” in a particular cell, a method for checking whether the system information about the cells used in carrier aggregation has been modified, through paging reception, was described. However, when the terminal receives a paging having the other cell modification set at “on” in the particular cell, a method for checking whether the system information has been modified may be used, by receiving system information containing the information necessary for maintaining the carrier aggregation from a cell broadcasting the system information about the cells used in the carrier aggregation. In this manner, the paging is received only from the particular cell, and the system information is received from a cell broadcasting the system information about the cells used in the carrier aggregation. Accordingly, while the functions are simplified, a paging is constantly received in all the cells. Thus, the problem of an increase in power consumption can be solved.

Although currently conceivable preferred embodiments of the present invention have been described so far, it is intended that various modifications may be made to those embodiments, and all those modifications within the spirit and scope of the inventions should be regarded as being included in the claims.

### INDUSTRIAL APPLICABILITY

As described so far, in a wireless communication system of the present invention, when the system information about each cell in carrier aggregation is modified, the necessary system information can be effectively received while the number of times a paging is transmitted or received is made smaller. Such a wireless communication should be useful as a wireless communication system or the like that performs wireless communications through carrier aggregation.

### EXPLANATION OF REFERENCE NUMERALS

10, 20, 30 Terminals
120, 220 System information management units
130, 230 Paging management units
132, 232 Other-cell system information modification determining units
140, 240, 340 Control units
50, 60, 70 Base stations
530, 630 Paging generating units
540, 640, 740 Control units

1. A wireless communication terminal that is capable of simultaneously using respective component carriers of a plurality of communication cells through carrier aggregation,
the wireless communication terminal comprising:
a receiving unit that receives a paging message and system information;
a paging management unit that determines whether there is a modification to system information about a communication cell from which the paging message has been received, and whether there is a modification to system information about the other communication cells, based on the paging message received by the receiving unit; and
a control unit that controls the receiving unit to receive a paging message about a particular communication cell among the plurality of communication cells, the control unit controlling the receiving unit to receive a paging message about another communication cell that is not the particular communication cell when the paging management unit determines, based on the paging message about the particular communication cell, that there is a modification to the system information about the other communication cells, the control unit controlling the receiving unit to receive the system information about the communication cell from which the paging message has been received when the paging management unit determines that there is a modification to the system information about the communication cell from which the paging message has been received.

2. The wireless communication terminal according to claim 1, wherein, after the control unit controls the receiving unit to receive a paging message about another communication cell, the control unit controls the receiving unit to stop reception of paging messages, when the paging management unit determines, based on the paging message about the another communication cell, that there is a modification to system information about the communication cell from which the paging message has been received, and that there is not a modification to system information about the other communication cells.

3. The wireless communication terminal according to claim 1, wherein, after the control unit controls the receiving unit to receive a paging message about another communication cell, the control unit controls the receiving unit to receive system information from all communication cells from which a paging message has not been received, when the paging management unit determines, based on the paging message about the another communication cell, that there is not a modification to system information about the communication cell from which the paging message has been received, and that there is not a modification to system information about the other communication cells.

4. The wireless communication terminal according to claim 1, wherein
the paging message about the particular communication cell contains information indicating whether modifications to system information about the other communication cells are the same as a modification to system information about the particular communication cell,
based on the paging message about the particular communication cell, the paging management unit determines whether the modifications to the system information about the other communication cells are the same as the modification to system information about the particular communication cell,
when the paging management unit determines that the modifications to the system information about the other communication cells are the same as the modification to the system information about the particular communication cell, the control unit modifies the system information about the communication cells used in the carrier aggregation in the same manner as the modification to the system information about the particular communication cell.

5. The wireless communication terminal according to claim 1, wherein
when the plurality of communication cells used in the carrier aggregation include a non-broadcasting cell that does not transmit a paging message nor system information, communication cells not used in the carrier aggregation include a surrogate broadcasting cell that transmits a paging message and system information on behalf of the non-broadcasting cell, and the paging management unit determines, based on the paging message about the particular communication cell, that there is a modification to system information about the non-broadcasting cell, and a paging message needs to be received from the surrogate broadcasting cell,
the control unit sets an interval period for the non-broadcasting cell in accordance with timing calculated based on information specific to the wireless communication terminal, and, during the interval period, controls the receiving unit to receive a paging message about the non-broadcasting cell from the surrogate broadcasting cell, and, when the paging management unit determines, based on the paging message received from the surrogate broadcasting cell, that there is a modification to the system information about the non-broadcasting cell, the control unit controls the receiving unit to receive the system information by switching from the non-broadcasting cell to the surrogate broadcasting cell.

6. The wireless communication terminal according to claim 1, wherein the modification to system information is a modification to system information necessary for maintaining the carrier aggregation.

7. The wireless communication terminal according to claim 6, wherein the modification to system information is a modification to a SIB 2.

8. A wireless communication base station that is capable of communicating with a wireless communication terminal by simultaneously using respective component carriers of a plurality of communication cells through carrier aggregation,
the wireless communication base station comprising:
a paging generating unit that generates a paging message for each of the communication cells when system information about one of the plurality of communication cells is modified, the paging message containing information indicating whether there is a modification to system information about a subject communication cell and information indicating whether there is a modification to system information about the communication cells other than the subject communication cell; and
a transmitting unit that transmits the paging message generated by the paging generating unit in the communication cell associated with the paging message.

9. The wireless communication base station according to claim 8, wherein, when system information necessary for maintaining the carrier aggregation is modified, the paging generating unit generates the paging message.

10. The wireless communication base station according to claim 8, wherein
the information indicating whether there is a modification to the system information about the other communication cells includes information indicating whether system information about all the communication cells other than a particular communication cell is modified in the same manner as system information about the particular communication cell among the plurality of communication cells, and
when the system information about all the other communication cells is modified in the same manner as the system information about the particular communication cell, the paging generating unit generates the paging message containing information indicating that the system information about all the other communication cells has been modified in the same manner as the system information about the particular communication cell, and, when part of or all of the system information about the other communication cells is modified in a different manner from the system information about the particular communication cell, the paging generating unit generates the paging message containing information indicating that the system information about all the other communication cells has not been modified in the same manner as the system information about the particular communication cell.

11. The wireless communication base station according to claim 8, wherein the modification to system information is a modification to system information necessary for maintaining the carrier aggregation.

12. A wireless communication system comprising:
a wireless communication base station and a wireless communication terminal,
the wireless communication system performing communications between the wireless communication base station and the wireless communication terminal by simultaneously using respective component carriers of a plurality of communication cells through carrier aggregation,
the wireless communication base station being capable of communicating with the wireless communication terminal by simultaneously using respective component carriers of a plurality of communication cells through carrier aggregation,
the wireless communication base station including:
a paging generating unit that generates a paging message for each of the communication cells when system information about one of the plurality of communication cells is modified, the paging message containing information indicating whether there is a modification to system information about a subject communication cell and information indicating whether there is a modification to system information about the communication cells other than the subject communication cell; and
a transmitting unit that transmits the paging message generated by the paging generating unit in the communication cell associated with the paging message, and transmits the system information,
the wireless communication terminal being capable of simultaneously using respective component carriers of a plurality of communication cells through carrier aggregation,
the wireless communication terminal including:
a receiving unit that receives the paging message and the system information transmitted from the transmitting unit;
a paging management unit that determines whether there is a modification to system information about the communication cell from which the paging message has been received, and whether there is a modification to system information about the other communication cells, based on the paging message received by the receiving unit; and
a control unit that controls the receiving unit to receive a paging message about a particular communication cell among the plurality of communication cells, the control unit controlling the receiving unit to receive a paging message about another communication cell that is not the particular communication cell when the paging management unit determines, based on the paging message about the particular communication cell, that there is a modification to the system information about the other communication cells, the control unit controlling the receiving unit to receive the system information about the communication cell from which the paging message has been received when the paging management unit determines that there is a modification to the system information about the communication cell from which the paging message has been received.

13. A method of receiving system information with a communication terminal that is capable of simultaneously using respective component carriers of a plurality of communication cells through carrier aggregation,
the method comprising:
receiving a paging message through a particular communication cell among the plurality of communication cells used in the carrier aggregation;
determining whether there is a modification to system information about the communication cells other than the particular communication cell, based on the paging message received through the particular communication cell;
receiving a paging message about another communication cell, when it is determined that there is a modification to system information about the other communication cells; and
receiving system information about the another communication cell, when it is determined, based on the paging messages received in the another communication cell, that there is a modification to the system information about the another communication cell.

14. The method according to claim 13, wherein, when it is determined, based on the paging message received in the another communication cell, that there is a modification to the system information about the another communication cell, and that there is not a modification to system information about the communication cells other than the another communication cell, reception of paging messages is stopped.

15. The method according to claim 13, wherein, when it is determined, based on the paging message received through the another communication cell, that there is not a modification to the system information about the another communication cell, and that there is not a modification to system information about the communication cells other than the another communication cell, system information is received from a communication cell from which a paging message has not been received.
